(19) United States
(12) Patent Application Publication
(10) Pub. No.: US 2024/0362822 A1
(43) Pub. Date: Oct. 31, 2024

(54) SIGNAL PROCESSING DEVICE AND SIGNAL PROCESSING METHOD

(71) Applicant: Sony Group Corporation, Tokyo (JP)

(72) Inventors: Motonobu FUJIOKA, Kanagawa (JP); Yusuke MORIUCHI, Kanagawa (JP); Kenichiro NAKAMURA, Saitama (JP); Takayuki SASAKI, Tokyo (JP); Hajime MIHARA, Tokyo (JP)

(73) Assignee: Sony Group Corporation, Tokyo (JP)

(21) Appl. No.: 18/573,988

(22) PCT Filed: Feb. 22, 2022
(86) PCT No.: PCT/JP2022/007088

§ 371 Date: Dec. 22, 2023

(30) Foreign Application Priority Data
Jul. 6, 2021 (JP) 2021-112318

(51) Int. Cl. G06T 7/90; G06T 7/44; G06T 7/521

(52) U.S. Cl. CPC G06T 7/90; G06T 7/44; G06T 7/521

(57) ABSTRACT

There is provided a signal processing device and a signal processing method capable of accurately acquiring distance information in a case where a transparent subject is present. The signal processing device includes an acquisition unit that acquires histogram data of a flight time of irradiation light to a subject, a transparent subject determination unit that determines whether or not the subject is a transparent subject on the basis of peak information indicated by the histogram data and three-dimensional coordinates of the subject calculated on the basis of the histogram data, and an output unit that outputs the three-dimensional coordinates of the subject in which color information or three-dimensional coordinates of the subject is corrected on the basis of a transparent subject determination result of the transparent subject determination unit. The technology of the present disclosure can be applied to, for example, a signal processing device and the like that corrects distance information acquired by a ToF sensor of a direct ToF system.

### TECHNICAL FIELD

The present disclosure relates to a signal processing device and a signal processing method, and especially relates to a signal processing device and a signal processing method capable of accurately acquiring distance information in a case where a transparent subject is present.

### BACKGROUND ART

A ToF sensor of a direct ToF system (hereinafter, also referred to as a dToF sensor) detects reflected light, which is pulse light reflected by an object, using a light receiving element referred to as a single photon avalanche diode (SPAD) in each pixel for light reception. Emission of the pulse light and reception of the reflected light thereof are repeatedly performed a predetermined number of times (for example, several to several hundred times) in order to suppress noise due to ambient light and the like. Then, the dToF sensor generates a histogram of a flight time of the pulse light, and calculates a distance to the object from the flight time corresponding to a peak of the histogram.

It is known that an SN ratio is low and it is difficult to detect a peak position in ranging of a low-reflectivity or distant subject, ranging in an environment where external light has a strong influence of disturbance such as an outdoor environment and the like. Therefore, by making a shape of the emitted pulse light a spot shape, a reach distance of the pulse light is expanded, in other words, the number of detection of the reflected light is increased. Since the spot-shaped pulse light is generally sparse pulse light, pixels that detect the reflected light are also sparse according to a spot diameter and an irradiation area.

For the purpose of improving the SN ratio and reducing power by efficient pixel driving in accordance with a sparse reflected light detection environment, a plurality of adjacent pixels (referred to as a multipixel) of a part of a pixel array is regarded as one large pixel, and is allowed to perform a light reception operation in multipixel unit to generate a histogram.

For example, Patent Document 1 discloses a method of increasing the SN ratio instead of lowering spatial resolution by forming the multipixel using optional number of adjacent pixels such as two by three, three by three, three by six, three by nine, six by three, six by six, and nine by nine, creating a histogram using signals of the formed multipixel, and performing ranging.

A ranging sensor such as a dToF sensor is used together with an RGB camera in, for example, a volumetric capture technology of generating a 3D object of a subject from a moving image imaged from multiple viewpoints and generating a virtual viewpoint image of the 3D object according to an optional viewing position. Furthermore, a ranging sensor such as a dToF sensor is also used together with an RGB camera in simultaneous localization and mapping (SLAM) and the like that simultaneously performs self-position estimation and environmental map creation.

### CITATION LIST

### Patent Document

Patent Document 1: Japanese Patent Application Laid-Open No. 2020-112443

### SUMMARY OF THE INVENTION

### Problems to be Solved by the Invention

Accurate ranging data is required to construct the above-described 3D shape and three-dimensional environment. However, in a case where a transparent subject is present, it is difficult to accurately acquire distance information.

The present disclosure has been achieved in view of such a situation, and an object thereof is to enable accurate acquisition of distance information in a case where there is a transparent subject.

### Solutions to Problems

A signal processing device according to an aspect of the present disclosure includes an acquisition unit that acquires histogram data of a flight time of irradiation light to a subject, a transparent subject determination unit that determines whether or not the subject is a transparent subject on the basis of peak information indicated by the histogram data and three-dimensional coordinates of the subject calculated on the basis of the histogram data, and an output unit that outputs the three-dimensional coordinates of the subject in which color information or three-dimensional coordinates of the subject is corrected on the basis of a transparent subject determination result of the transparent subject determination unit.

A signal processing method according to an aspect of the present disclosure, a signal processing device acquires histogram data of a flight time of irradiation light to a subject, determines whether or not the subject is a transparent subject on the basis of peak information indicated by the histogram data and three-dimensional coordinates of the subject calculated on the basis of the histogram data, and outputs the three-dimensional coordinates of the subject in which color information or three-dimensional coordinates of the subject is corrected on the basis of a determination result of the transparent subject.

In an aspect of the present disclosure, histogram data of a flight time of irradiation light to a subject is acquired, it is determined whether or not the subject is a transparent subject on the basis of peak information indicated by the histogram data and three-dimensional coordinates of the subject calculated on the basis of the histogram data, and the three-dimensional coordinates of the subject in which color information or three-dimensional coordinates of the subject is corrected on the basis of a determination result of the transparent subject is detected.

The signal processing device may be an independent device or may be a module incorporated in another device.

### BRIEF DESCRIPTION OF DRAWINGS

FIG. 1 is a block diagram illustrating a configuration example of a first embodiment of a signal processing system of the present disclosure.

FIG. 2 is a diagram illustrating operations of an RGB camera and a dToF sensor in FIG. 1.

FIG. 3 is a diagram illustrating the dToF sensor.

FIG. 4 is a diagram illustrating a transparent 20 subject.

FIG. 5 is a diagram illustrating processing of a transparent subject determination unit.

FIG. 6 is a diagram illustrating processing in a case where a thermal camera is used.

FIG. 7 is a diagram illustrating processing of a candidate prediction unit.

FIG. 8 is a diagram illustrating processing of a candidate prediction unit.

FIG. 9 is a diagram illustrating NeRF, which is a type of neural network.

FIG. 10 is a diagram illustrating a case where NeRF is applied to prediction processing of a color candidate.

FIG. 11 is a diagram illustrating processing of a DB update unit.

FIG. 12 is a diagram illustrating processing of a DB update unit.

FIG. 13 is a diagram illustrating a variation in which likelihood is output as reliability.

FIG. 14 is a flowchart illustrating color information correction processing by the signal processing system of the first embodiment.

FIG. 15 is a block diagram illustrating a variation of the first embodiment of the signal processing system.

FIG. 16 is a diagram illustrating positional shift of three-dimensional coordinates due to refraction of light of a transparent subject.

FIG. 17 is a block diagram illustrating a configuration example of a second embodiment of a signal processing system of the present disclosure.

FIG. 18 is a diagram illustrating processing of a candidate prediction unit.

FIG. 19 is a diagram illustrating processing of a DB update unit.

FIG. 20 is a diagram illustrating a case where D-NeRF is applied to prediction processing of a color candidate.

FIG. 21 is a flowchart illustrating positional shift correction processing by the signal processing system of the second embodiment.

FIG. 22 is a block diagram illustrating a configuration example of hardware of a computer that executes signal processing of the present disclosure.

### MODE FOR CARRYING OUT THE INVENTION

Hereinafter, modes for carrying out the technology of the present disclosure (hereinafter, referred to as embodiments) will be described with reference to the accompanying drawings. Note that, in this specification and the drawings, the components having substantially the same function configuration are assigned with the same reference sign and the description thereof is not repeated. The description will be given in the following order.
1. First Embodiment of Signal Processing System
2. Color Information Correction Processing according to First Embodiment
3. Variation of First Embodiment
4. Second Embodiment of Signal Processing System
5. Positional Shift Correction Processing according to Second Embodiment
6. Conclusion
7. Computer Configuration Example

### 1. First Embodiment of Signal Processing System

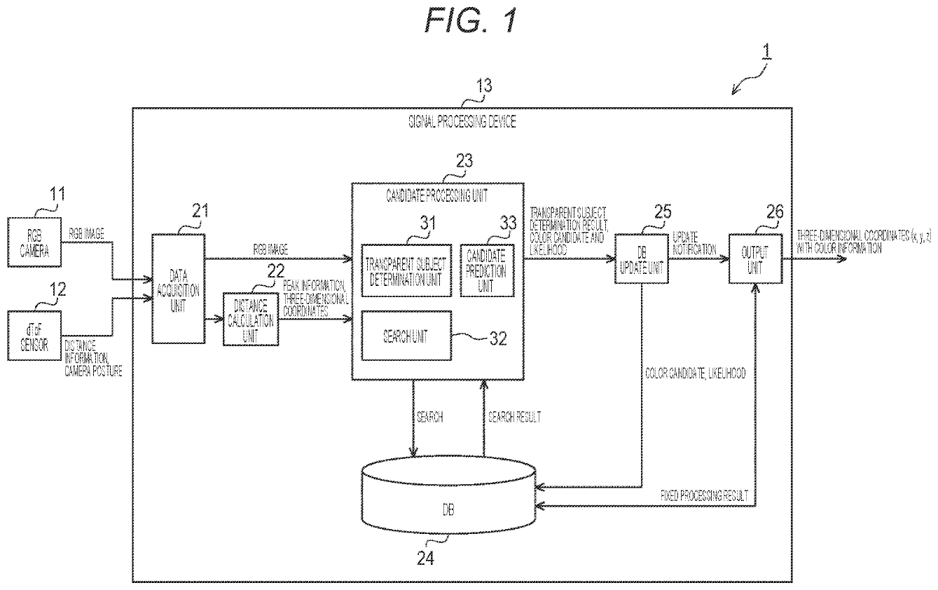

FIG. 1 is a block diagram illustrating a configuration example of a first embodiment of a signal processing system of the present disclosure.

A signal processing system 1 in FIG. 1 includes an RGB camera 11, a dToF sensor 12, and a signal processing device 13.

The signal processing device 13 includes a data acquisition unit 21, a distance calculation unit 22, a candidate processing unit 23, a DB 24, a DB update unit 25, and an output unit 26. The candidate processing unit 23 includes a transparent subject determination unit 31, a search unit 32, and a candidate prediction unit 33.

The RGB camera 11 images a predetermined object as a subject, generates (a moving image of) an RGB image, and supplies the same to the signal processing device 13. The dToF sensor 12 is a ranging sensor that measures distance information by a direct ToF system, and measures a distance to the same object as the object imaged by the RGB camera 11. In the present embodiment, in order to simplify the description, it is assumed that the distance information is generated from the dToF sensor 12 at the same frame rate in synchronization with a frame rate of the moving image generated by the RGB camera 11.

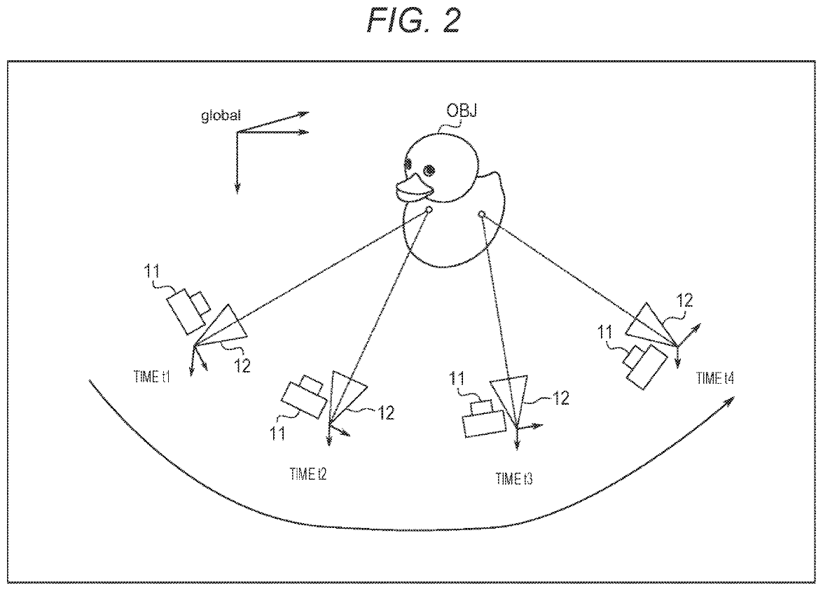

As illustrated in FIG. 2, the RGB camera 11 images an object OBJ as a subject while moving an imaging location with a lapse of time, and generates an RGB image. The dToF sensor 12 also moves together with the RGB camera 11, and receives reflected light, which is a plurality of spot lights (irradiation light beams) emitted from a light emitting source not illustrated reflected by the object OBJ, thereby measuring a distance to the object OBJ. A relative positional relationship between the RGB camera 11 and the dToF sensor 12 is fixed, and imaging ranges of the RGB camera 11 and the dToF sensor 12 are calibrated. In other words, the imaging ranges of the RGB camera 11 and the dToF sensor 12 are the same, and a correspondence relationship between the pixels of the RGB camera 11 and the dToF sensor 12 is known. In the present embodiment, in order to simplify the description, it is assumed that a difference in position between the RGB camera 11 and the dToF sensor 12 is negligible, and the camera positions (camera postures) of the RGB camera 11 and the dToE sensor 12 are the same.

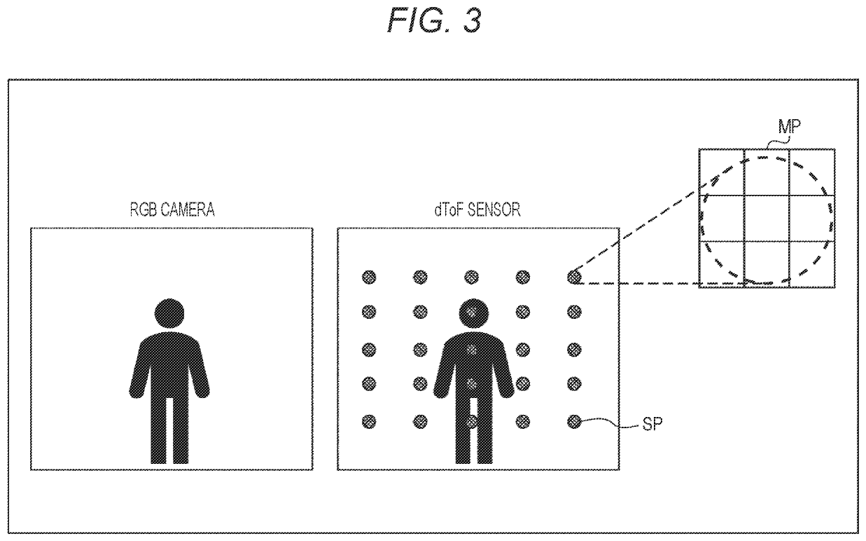

The dToF sensor 12 is briefly described with reference to FIG. 3.

The dToF sensor 12 detects the reflected light, which is pulse light as irradiation light reflected by an object to return, using a light receiving element referred to as a single photon avalanche diode (SPAD) in each pixel for light reception. In order to reduce noise caused by ambient light or the like, the dToF sensor 12 repeats emission of the pulse light and reception of the reflected light thereof a predetermined number of times (for example, several to several hundred times) to generate a histogram of time of flight of the pulse light, and calculates a distance to the object from the time of flight corresponding to a peak of the histogram.

Furthermore, it is known that an SN ratio is low and it is difficult to detect a peak position in ranging of a low-reflectivity or distant subject, ranging in an environment where external light has a strong influence of disturbance such as an outdoor environment and the like. Therefore, by making a shape of the emitted pulse light a spot shape, a reach distance of the pulse light is expanded, in other words, the number of detection of the reflected light is increased. Since the spot-shaped pulse light is generally sparse pulse light, pixels that detect the reflected light are also sparse according to a spot diameter and an irradiation area. FIG. 3 illustrates an example in which the same imaging range as that of the RGB camera 11 is irradiated with 25 (five by five) spot lights SP, and the reflected light, which is each spot light SP reflected by an object, is detected.

For the purpose of improving an SN ratio and reducing power by efficient pixel driving in accordance with a sparse reflected light detection environment, the dToF sensor 12 makes a plurality of adjacent pixels a multipixel MP in accordance with sparse spot lights SP, allows only a plurality of multipixels MP out of all the pixels of the pixel array to perform a light receiving operation, and generates a histogram in multipixel MP unit. In the example in FIG. 3, the multipixel MP of nine pixels (three by three) is set for one spot light SP.

Note that, in FIG. 3, an example of 25 (five by five) spot lights SP and the multipixel MP of nine pixels (three by three) is described, but the number and arrangement of the spot lights SP and the multipixel MP are optional. In the following description, in a case where the spot light SP and the multipixel MP are not particularly distinguished, a point corresponding to them is also referred to as a ranging point.

The RGB camera 11 in FIG. 1 generates (the moving image of) the RGB image obtained by sequentially imaging a predetermined object as the subject, and supplies the same to the signal processing device 13. The dToF sensor 12 supplies the distance information obtained by measuring in synchronization with the RGB camera 11 and the camera posture when acquiring the distance information to the signal processing device 13. The distance information includes a pixel position (x, y) corresponding to the center of the spot light SP detected by the dToF sensor 12 and histogram data. The camera posture is information of an external parameter of the dToF sensor 12 detected by an inertial measurement unit (IMU) in the dToF sensor 12. Note that, the dToF sensor 12 is not required to include the inertial measurement unit (IMU). In that case, the dToF sensor 12 outputs only the distance information, and the camera posture of the dToF sensor 12 is calculated by calculating three-dimensional position information of the corresponding (same) ranging point in each frame by a method such as normal distribution transform in the distance calculation unit 22 and the like in the signal processing device 13, for example.

The signal processing device 13 corrects color information of an object caused by a transparent subject on the basis of the RGB image acquired from the RGB camera 11 and the distance information and camera posture acquired from the dToF sensor 12, and outputs three-dimensional coordinates with color information. The three-dimensional coordinates with color information of the object include three-dimensional coordinates (x, y, z) on a global coordinate system, which is position information of the object, and the color information. In the following description, unless otherwise specified, the three-dimensional coordinates (x, y, z) represent the three-dimensional coordinates (x, y, z) on the global coordinate system.

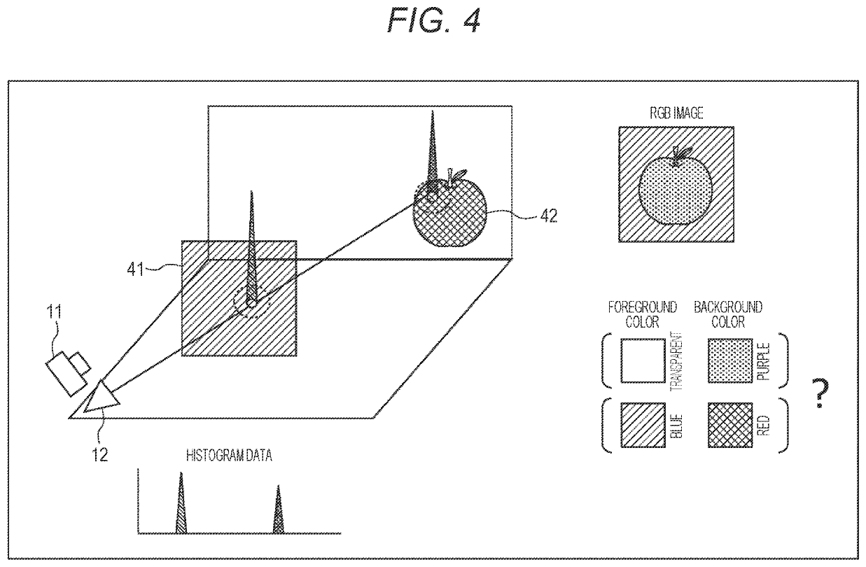

For example, as illustrated in FIG. 4, the RGB camera 11 and the dToF sensor 12 image a transparent subject 41 colored in blue and a red apple 42 behind the transparent subject 41 in a line-of-sight direction as subjects. In the RGB image generated by the RGB camera 11, the color of the apple 42 is shown as purple mixed with blue of the transparent subject 41 that is a foreground. The signal processing device 13 determines whether there is no blue transparent subject 41 and there is a purple apple 42, there is the blue transparent subject 41 and there is the red apple 42, or the like. The signal processing device 13 corrects the color of the apple 42 shown as purple due to the transparent subject 41 to red, and outputs the corrected color information and three-dimensional coordinates (x, y, z).

Specifically, the signal processing device 13 determines whether the transparent subject is present or not using the histogram data output as the distance information by the dToF sensor 12, and corrects the color information on the basis of a determination result thereof. In a case where the transparent subject is present, as in the histogram data illustrated in FIG. 4, a plurality of peaks including at least a peak at which the reflected light reflected by the transparent subject 41 is received and a peak at which the reflected light reflected by the apple 42 is received are detected. The signal processing device 13 analyzes peak information of such histogram data to detect presence or absence of the transparent subject and corrects the color information.

With reference to FIG. 1 again, the data acquisition unit 21 of the signal processing device 13 acquires the RGB image supplied from the RGB camera 11, and the distance information and the camera posture supplied from the dToF sensor 12. The data acquisition unit 21 supplies the acquired RGB image to the candidate processing unit 23, and supplies the acquired distance information and camera posture to the distance calculation unit 22.

The distance calculation unit 22 calculates one or more pieces of peak information and three-dimensional coordinates (x, y, z) for each ranging point of the dToF sensor 12 on the basis of the distance information and camera posture from the data acquisition unit 21. More specifically, the distance calculation unit 22 extracts the peak information corresponding to the peak of the count value from the histogram data of the multipixel MP corresponding to the spot light SP, and calculates the three-dimensional coordinates (x, y, z) from the extracted peak information and the camera posture. Here, the peak information corresponding to one peak includes at least information of a bin having the count value equal to or larger than a predetermined value and having the largest count value (peak) among a plurality of adjacent bins, and count values of a plurality of bins around the bin. The plurality of bins around the peak may be defined as, for example, a predetermined number of bins before and after the bin of the peak, or may be defined as bins around the peak having the count value equal to or larger than a certain proportion (for example, half) of the count value of the peak.

In general, in a case where there is no transparent subject in the imaging range, one peak is observed in the histogram, and one piece of peak information and three-dimensional coordinates (x, y, z) are calculated. In contrast, in a case where the transparent subject is present in the imaging range, or in a case where the spot light strikes a boundary of the object, a plurality of peaks is extracted, and peak information and three-dimensional coordinates (x, y, z) are calculated for each extracted peak.

The distance calculation unit 22 supplies the extracted peak information of each peak and three-dimensional coordinates (x, y, z) to the candidate processing unit 23. Note that, the distance calculation unit 22 may supply the histogram data as it is to the candidate processing unit 23 in place of the peak information.

The transparent subject determination unit 31, the search unit 32, and the candidate prediction unit 33 of the candidate processing unit 23 perform following processing for each ranging point of the dToF sensor 12.

The transparent subject determination unit 31 acquires the peak information and the three-dimensional coordinates (x, y, z) of the ranging point from the distance calculation unit 22 as transparent subject determination information, and determines whether or not the subject is the transparent subject on the basis of the transparent subject determination information.

The search unit 32 searches whether three-dimensional coordinates with unfixed color information having three-dimensional coordinates within a search range of (x±Δx, y±Δy, z±Δz) obtained by adding a predetermined margin to the three-dimensional coordinates (x, y, z) of the ranging point supplied from the distance calculation unit 22 are stored in the DB 24 or not. Margin values Δx, Δy, and Δz of the three-dimensional coordinates are set in advance.

In a case where the three-dimensional coordinates with unfixed color information having three-dimensional coordinates within the search range are not stored in the DB 24, the search unit 32 supplies a search result of “not applicable” to the candidate prediction unit 33. In contrast, in a case where the three-dimensional coordinates with unfixed color information having three-dimensional coordinates within the search range are stored in the DB 24, the search unit 32 acquires, from the DB 24, a provisional processing result candidate for a past frame including the three-dimensional coordinates with unfixed color information and color candidates, and supplies the same to the candidate prediction unit 33 as the search result. The coordinate values of the three-dimensional coordinates with unfixed color information are, of course, the coordinate values within the search range.

The candidate prediction unit 33 predicts the color information for the three-dimensional coordinates (x, y, z) of the ranging point supplied from the distance calculation unit 22 on the basis of the RGB image from the RGB camera 11, the transparent subject determination result by the transparent subject determination unit 31, and the search result from the search unit 32. The candidate prediction unit 33 supplies a pair of candidate (color candidate) of the color information and likelihood to the DB update unit 25 as a prediction result of the color information. Here, the likelihood is a value in a range from 0 to 1 expressing a degree of certainty of the processing result, and is used when fixing a processing result by comparing the same with a threshold determined in advance. Furthermore, the candidate prediction unit 33 also supplies the transparent subject determination result by the transparent subject determination unit 31 to the DB update unit 25.

The DB 24 is a storage unit that stores the three-dimensional coordinates (x, y, z) on the global coordinate system and the color information based on the RGB image supplied from the candidate processing unit 23 for each ranging point of the dToF sensor 12. In the DB 24, a plurality of possible color candidates is stored as the provisional processing result candidates for the ranging point with unfixed color information. The provisional processing result candidates are stored as pairs of color candidate and likelihood.

On the basis of the transparent subject determination result and the pair of color candidate and likelihood supplied from the candidate prediction unit 33, the DB update unit 25 updates the provisional processing result candidate for the three-dimensional coordinates with unfixed color information stored in the DB 24. In a case of updating the information stored in the DB 24, the DB update unit 25 supplies an update notification to the output unit 26.

In a case where the update notification is supplied from the DB update unit 25, the output unit 26 outputs the three-dimensional coordinates with color information, which is the fixed processing result stored in the DB 24. The three-dimensional coordinates with color information include the three-dimensional coordinates (x, y, z) of the ranging point and the color information of the coordinates.

The signal processing device 13 has the above-described configuration. Hereinafter, detailed processing of each unit of the signal processing device 13 will be further described.

First, processing of the transparent subject determination unit 31 will be described.

The transparent subject determination unit 31 determines whether or not the subject is the transparent subject on the basis of the transparent subject determination information from the distance calculation unit 22.

Specifically, in a case where one peak is observed in the histogram of one multipixel MP, the transparent subject determination unit 31 determines that the subject is not the transparent subject.

In contrast, in a case where a plurality of peaks is observed in the histogram of one multipixel MP, it is considered that the peaks are due to the spot light hitting the object boundary and due to the transparent subject. Therefore, in a case where a plurality of peaks is observed in the histogram of one multipixel MP, the transparent subject determination unit 31 determines whether the plurality of peaks is due to the object boundary or the transparent subject as follows.

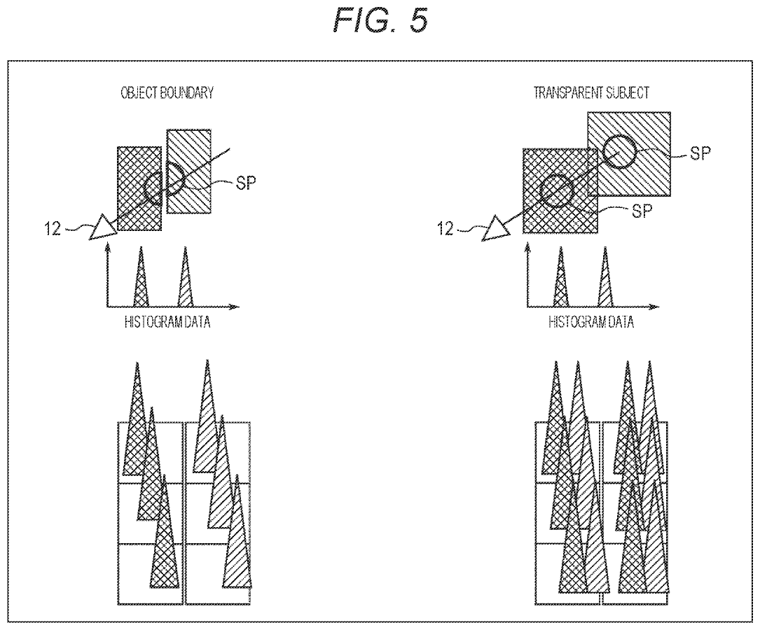

For example, as illustrated in FIG. 5, the transparent subject determination unit 31 checks whether or not peaks have different distributions in a plurality of pixels forming one multipixel MP. That is, as illustrated on a right side in FIG. 5, in a case where a plurality of peaks is uniformly counted in each pixel forming the multipixel MP, the transparent subject determination unit 31 determines that the subject is the transparent subject. In contrast, as illustrated on a left side in FIG. 5, in a case where there is a bias in pixels where peaks are detected, such as a case where a first peak is detected in some pixels of the multipixel MP and a second peak is detected in other pixels of the multipixel MP, the transparent subject determination unit 31 determines that the plurality of peaks is due to the object boundary and determines that the subject is not the transparent subject.

Alternatively, it is also possible to solve a boundary identification problem of separating the histogram and measurement points using the three-dimensional coordinates (x, y, z) corresponding to the peak, and determine whether the plurality of peaks is due to the object boundary or the transparent subject using an identification boundary surface, which is an identification result. The transparent subject determination unit 31 determines that the plurality of peaks is due to the object boundary in a case where the identification boundary surface passes on the multipixel MP of an xy plane, and determines that the subject is the transparent subject in a case where the identification boundary surface does not pass on the multipixel MP of the xy plane. For determining the identification boundary surface, for example, two-class linear SVM, logistic regression, K neighborhood search, linear SVM, random forest regression and the like can be used.

The above-described method is a method of determining whether the plurality of peaks is due to the object boundary or the transparent subject using only the distribution of the peaks in the multipixel MP, but it may be determined whether the plurality of peaks is due to the object boundary or the transparent subject using additional sensor information. For example, the above-described determination can be made by using a thermal camera as an additional sensor and utilizing a property that glass does not allow far infrared rays to pass.

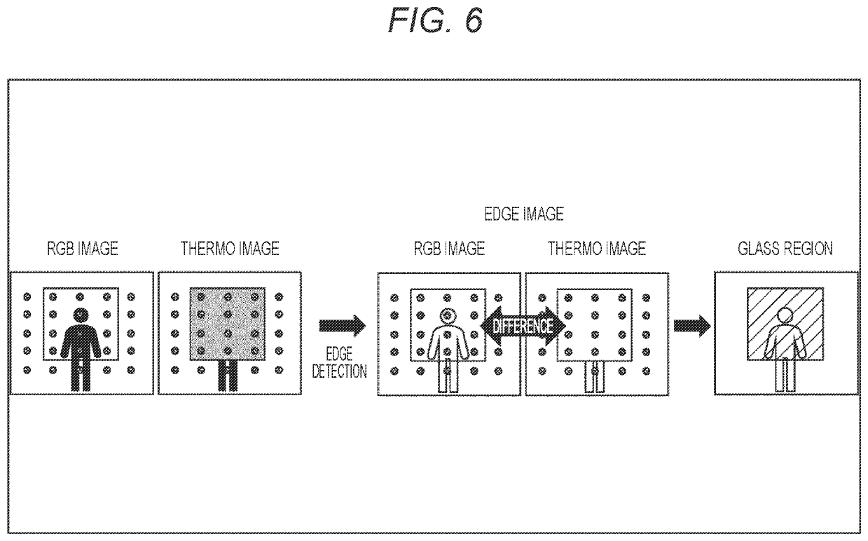

Specifically, as illustrated in FIG. 6, an edge is detected in a region where two or more peaks are observed in each of the RGB image obtained by the RGB camera 11 and a thermo image obtained by a thermal camera, using, for example, Canny's method and the like. Then, the transparent subject determination unit 31 compares regions formed by edges of the RGB image and the thermo image, recognizes a region having a difference as a glass region, and determines that the region is the transparent subject.

As described above, the transparent subject determination unit 31 may determine whether the plurality of peaks is due to the object boundary or the transparent subject using only the distribution of the peaks in the multipixel MP, and may determine the same by using another sensor information. The determination can be made with high accuracy by using other sensor information. It is possible to determine by selecting any one of the methods, or determine whether the plurality of peaks is due to the object boundary or the transparent subject by using a plurality of determination methods.

Next, processing of the candidate prediction unit 33 will be described.

The candidate prediction unit 33 predicts the color information for the three-dimensional coordinates (x, y, z) of each ranging point supplied from the distance calculation unit 22 on the basis of the RGB image from the RGB camera 11, the transparent subject determination result by the transparent subject determination unit 31, and the search result from the search unit 32.

First, a case where a search result of “not applicable” is supplied from the search unit 32 will be described. A case where the search result of “not applicable” is supplied from the search unit 32 is a case where the RGB image input from the RGB camera 11 is a first frame, a case where three-dimensional coordinates with unfixed color information are not stored in the DB 24 and the like.

The candidate prediction unit 33 predicts the pair of color candidate and likelihood for the three-dimensional coordinates (x, y, z) of each ranging point supplied from the distance calculation unit 22 on the basis of the RGB image from the RGB camera 11 and the transparent subject determination result by the transparent subject determination unit 31. The candidate prediction unit 33 predicts the pair of color candidate and likelihood in a predetermined order for the three-dimensional coordinates (x, y, z) of all the ranging points supplied from the distance calculation unit 22, and a ranging point currently focused as a prediction target is referred to as a ranging point of interest.

In a case where the transparent subject determination result of the ranging point of interest is not the transparent subject, the candidate prediction unit 33 supplies a prediction result of color information in which the color information of the RGB image of the ranging point of interest is set as a color candidate as it is and the likelihood is set to “1” to the DB update unit 25.

In contrast, in a case where the transparent subject determination result of the ranging point of interest is the transparent subject, the candidate prediction unit 33 determines a plurality of pairs of color candidate and likelihood by a rule determined in advance or by learning, and supplies the same to the DB update unit 25.

For example, the candidate prediction unit 33 determines a plurality of pairs of color candidate and likelihood as follows.

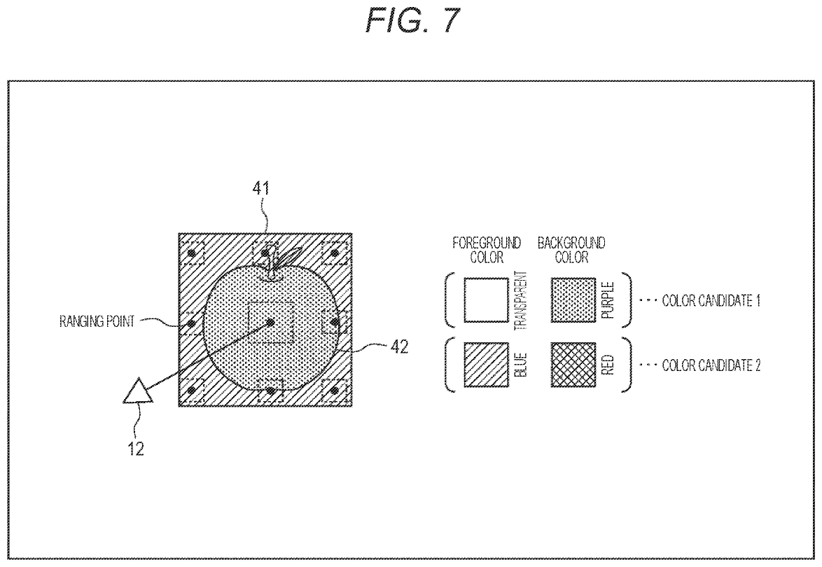

As in a color candidate 1 in FIG. 7, the candidate prediction unit 33 determines a foreground color to be transparent and a background color to be a color (purple) of the ranging point of interest of the RGB image supposing that the foreground is the transparent subject.

Next, the candidate prediction unit 33 acquires a recognition processing result obtained by subjecting the RGB image to object recognition processing from an external device, and determines the foreground color and the background color by using color information assumed from the recognition processing result. In the example in FIG. 7, “apple” is input to the signal processing device 13 as the recognition processing result, color information of a recognition region of the apple is set to red, the foreground color is determined to be blue obtained by subtracting red of the apple from purple of the RGB image and the background color is determined to be red of the apple as in the color candidate 2 in FIG. 7.

Next, the candidate prediction unit 33 determines the color information at an adjacent ranging point (spot light) of the ranging point of interest as the foreground color, and determines the background color as the color of the ranging point of interest. In the example in FIG. 7, since the color information of the adjacent ranging point on a left side of the ranging point of interest at the center is blue, the foreground color is determined to be blue, and the background color is determined to be red obtained by subtracting blue from purple, similarly to the color candidate 2 in FIG. 7.

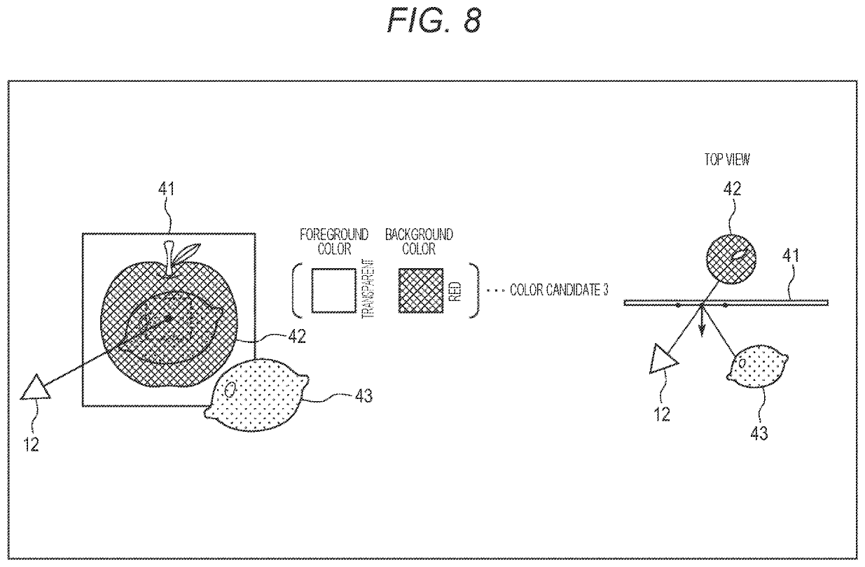

Next, the candidate prediction unit 33 assumes reflection of another object, and subtracts a color in a case where the reflection occurs to determine the foreground color and the background color. For example, as in a color candidate 3 in FIG. 8, reflection of yellow of lemon is assumed, the foreground color is determined to be transparent, and the background color is determined to be red obtained by subtracting yellow.

The above-described example is an example in which a plurality of color candidates for the foreground color and the background color is determined by a rule determined in advance on the assumption of a situation, but the color candidate may be determined by predicting the color information of the ranging point of interest using a predictor that learns the color information of each point forming an imaging space by a neural network. As the neural network that learns and predicts color information of each point forming the imaging space, for example, NeRF, which is a type of neural network, can be used. NeRF is disclosed in, for example, “NeRF: Representing Scenes as Neural Radiance Fields for View Synthesis”, Ben Mildenhall, Pratul P. Srinivasan, Matthew Tancik, Jonathan T. Barron, Ravi Ramamoorthi, Ren Ng, https://arxiv.org/abs/2003.08934.

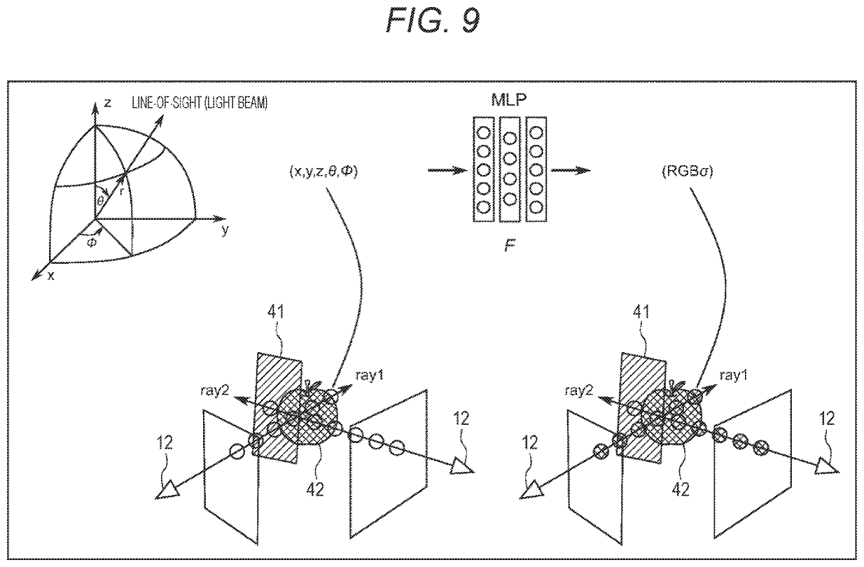

In NeRF, as illustrated in FIG. 9, the RGB images of a plurality of viewpoints and camera postures (x, y, z, θ, φ) at that time are input, and a function F of multilayer perceptron (MLP) that outputs luminance (RGB value) and density σ (RGBσ) of each point in the imaging space is learned. Here, (θ, φ) being a parameter of the camera posture corresponds to a line-of-sight direction from a three-dimensional position (x, y, z) of the RGB camera 11, θ represents a zenith angle, and φ represents an azimuth angle. Furthermore, the density σ of the output represents the likelihood that an object of the RGB values is present in the line-of-sight direction (θ, φ) of the input. In other words, in NeRF, using the luminance values of the RGB images imaged from multiple viewpoints as a teacher, the parameters of the MLP are learned in such a manner that a difference between the luminance value rendered by integrating (RGB, c) on the light beam (θ, φ) and a correct luminance value is minimized. Then, the luminance (RGB value) and the density σ (RGBσ) at the time t can be predicted (output) by inputting the RGB images and the camera postures (x, y, z, θ, φ) up to a time t−1 using the function F of the MLP obtained by learning as a predictor.

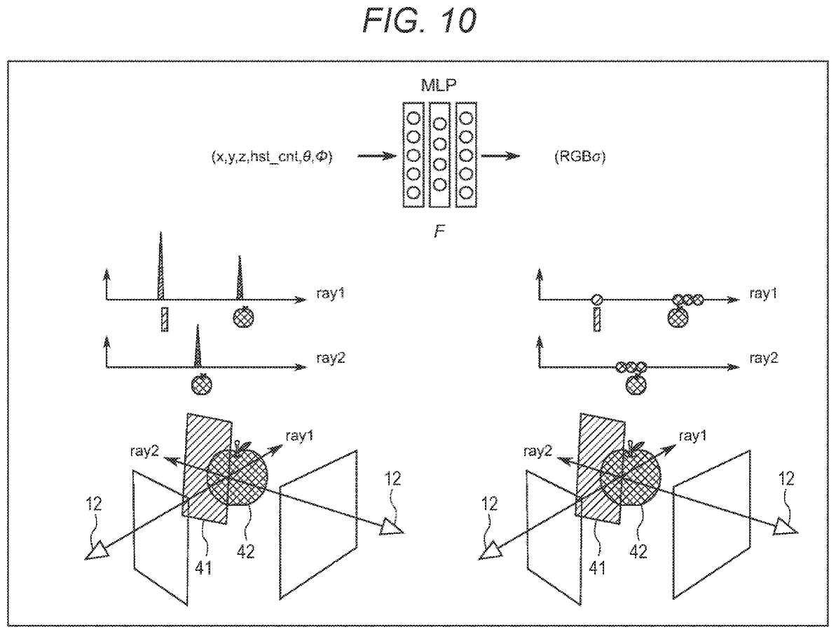

In a case where NeRF is applied to color candidate prediction processing, as illustrated in FIG. 10, the function F of MLP is learned using histogram data hst_cnt as an input in addition to the RGB image and the camera posture (x, y, z, θ, φ) at that time. In this manner, by adding the histogram data hst_cnt as the input data of learning, the luminance (RGB value) and the density σ (RGBσ) at the time t can be predicted with higher accuracy.

A method of calculating the color candidate described above is an example, and there is no limitation. The number of cases considered as color candidates calculated to be determined can vary depending on calculation resources such as a CPU and a memory size.

Next, the candidate prediction unit 33 determines the likelihood for the plurality of determined color candidates. The likelihood of each color candidate may be set in such a manner that the likelihoods of the respective color candidates are equal in a case where there is no particular prior knowledge, or for example, the likelihood of the color candidate in a case where the foreground is the transparent subject may be set higher than the likelihoods of the other color candidates. Furthermore, for example, in a case where the color of the subject can be estimated to some extent in advance, the likelihood of the predetermined color candidate may be set high accordingly. For example, in a case where there is a surrounding ranging point already processed and the surrounding ranging point is estimated to be blue glass, the likelihood of the color candidate of blue for the foreground and red for the background can be set high. Furthermore, for example, in a case where the imaging environment (subject) is known in advance, the likelihood of the color candidate corresponding to the imaging environment can be set high.

The candidate prediction unit 33 supplies the plurality of pairs of color candidate and likelihood determined as described above to the DB update unit 25.

Next, determination of the pairs of color candidate and likelihood of the candidate prediction unit 33 in a case where the provisional processing result candidates for the past frame having coordinates within the search range are supplied from the search unit 32 will be described.

In a case where the transparent subject determination result of the ranging point of interest is not the transparent subject, the candidate prediction unit 33 supplies a prediction result of color information in which the color information of the RGB image of the ranging point of interest is set as a color candidate as it is and the likelihood is set to “1” to the DB update unit 25.

In contrast, in a case where the transparent subject determination result of the ranging point of interest is the transparent subject, when there is a color candidate other than the provisional processing result candidate stored in the DB 24, the candidate prediction unit 33 determines a pair of the color candidate and likelihood and supplies the same to the DB update unit 25. A method of determining the color candidate is similar to that in a case where the provisional processing result candidate for the past frame is not stored in the DB 24.

Next, processing of the DB update unit 25 will be described.

On the basis of the transparent subject determination result and the pair of color candidate and likelihood supplied from the candidate prediction unit 33, the DB update unit 25 updates the provisional processing result candidate for the three-dimensional coordinates with unfixed color information stored in the DB 24.

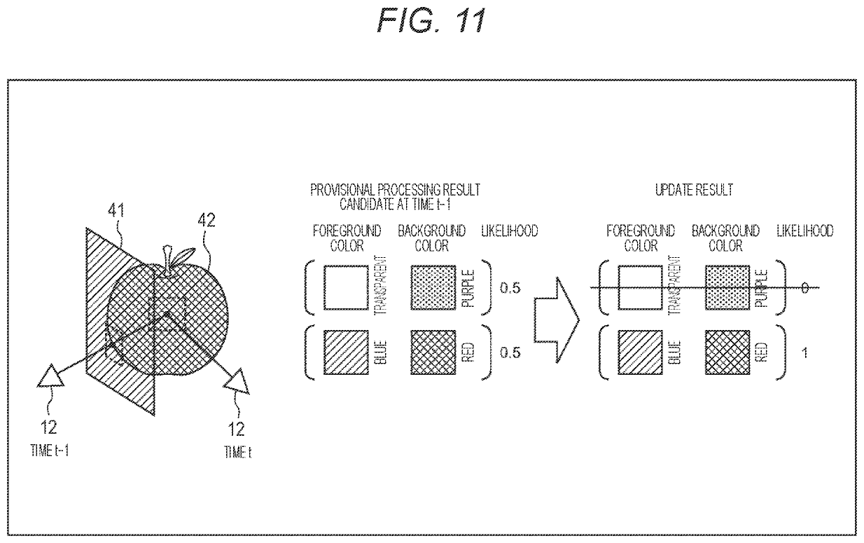

FIG. 11 illustrates an example of update of the provisional processing result candidate in a case where the transparent subject determination result by the transparent subject determination unit 31 is not the transparent subject.

In a case where the transparent subject determination result is not the transparent subject, the color information of the RGB image of the ranging point of interest is supplied as it is as the color candidate to the DB update unit 25 with the likelihood “1”.

In the example in FIG. 11, at a time t−1, the color candidate of [foreground color, background color, likelihood]=[transparent, purple, 0.5] and the color candidate of [foreground color, background color, likelihood]=[blue, red, 0.5] are stored in the DB update unit 25 as the provisional processing result candidates.

By the processing of the candidate prediction unit 33 at a time t, the transparent subject determination result of the ranging point of interest is not the transparent subject, and a prediction result of the color information in which the color information “red” of the RGB image of the ranging point of interest is set as the color candidate and the likelihood is set to “1” is supplied to the DB update unit 25.

The DB update unit 25 corrects the likelihood of the color candidate of [foreground color, background color, likelihood]=[blue, red, 0.5] including “red” out of the color candidate of [foreground color, background color, likelihood]=[transparent, purple, 0.5] and the color candidate of [foreground color, background color, likelihood]=[blue, red, 0.5], which are the provisional processing result candidates, to “1”, and deletes the other color candidate of [foreground color, background color, likelihood]=[transparent, purple, 0.5] from the DB 24. After updating the DB 24, the DB update unit 25 supplies an update notification to the output unit 26.

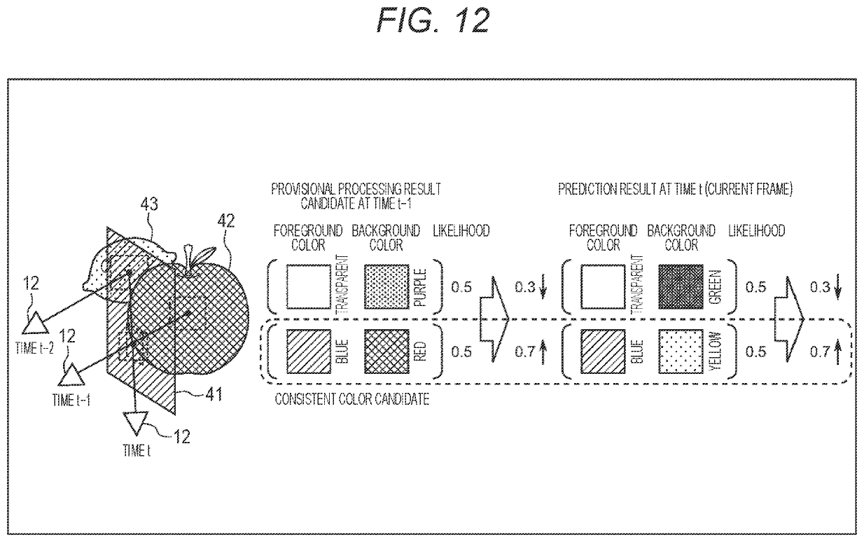

FIG. 12 illustrates an example of update of the provisional processing result candidate in a case where the transparent subject determination result by the transparent subject determination unit 31 is the transparent subject.

At the time t−1, the color candidate of [foreground color, background color, likelihood]=[transparent, purple, 0.5] and the color candidate of [foreground color, background color, likelihood]=[blue, red, 0.5] are stored in the DB update unit 25 as the provisional processing result candidates.

By the processing of the candidate prediction unit 33 at the time t that is a current frame, the transparent subject determination result at the ranging point of interest is the transparent subject, and the prediction results of the color candidate of [foreground color, background color, likelihood]=[transparent, green, 0.5] and the color candidate of [foreground color, background color, likelihood]=[blue, yellow, 0.5] are supplied to the DB update unit 25.

In a case where there is a consistent color candidate among a candidate group of the provisional processing result candidate at the time t−1 and the prediction result of the color candidate at the time t of the current frame, the DB update unit 25 updates the DB update unit 25 so as to increase the likelihood of the color candidate and reduce the likelihood of other color candidates. Here, the consistent color candidate means a color candidate that does not cause inconsistency when the color information of the related coordinates is fixed back to the past frame.

In the example in FIG. 12, at the time t−1, the color candidate of [foreground color, background color, likelihood]=[transparent, purple, 0.5] and the color candidate of [foreground color, background color, likelihood]=[blue, red, 0.5] are stored in the DB update unit 25 as the provisional processing result candidates. By the processing of the candidate prediction unit 33 at a next time t, the prediction results of the color candidate of [foreground color, background color, likelihood]=[transparent, green, 0.5] and the color candidate of [foreground color, background color, likelihood]=[blue, yellow, 0.5] are supplied to the DB update unit 25.

Then, in a case where the prediction result at a time t−2 is not the transparent subject but the color information of yellow and the likelihood of “1”, the prediction result of [foreground color, background color, likelihood]=[blue, yellow, 0.5] at the time t having the yellow color information is consistent with the prediction result of [foreground color, background color, likelihood]=[blue, red, 0.5] of the provisional processing result candidate at the time t−1 having the same foreground color.

Therefore, the DB update unit 25 updates the likelihood of the color candidate of [foreground color, background color, likelihood]=[transparent, purple, 0.5] as the provisional processing result candidate at the time t−1 “from 0.5 to 0.3”, and updates the likelihood of the color candidate of [foreground color, background color, likelihood]=[blue, red, 0.5] “from 0.5 to 0.7”. Furthermore, the DB update unit 25 updates the likelihood of the color candidate of [foreground color, background color, likelihood]=[transparent, green, 0.5] at the time t “from 0.5 to 0.3”, and updates the likelihood of the color candidate of [foreground color, background color, likelihood]=[blue, yellow, 0.5] at the time t “from 0.5 to 0.7”. After updating the DB 24, the DB update unit 25 supplies an update notification to the output unit 26.

In a case where there is a color candidate having likelihood smaller than a lower limit threshold (second threshold) determined in advance in the provisional processing result candidates due to the update of the DB 24, the DB update unit 25 deletes the color candidate from the provisional processing result candidates of the DB 24.

In a case where the candidate prediction unit 33 uses the predictor learned by NeRF described above, the prediction result of the RGB value and the density σ (RGB) is updated after relearning the parameter (weight) of the MLP, and the provisional processing result candidate of the DB 24 is updated.

Next, processing of the output unit 26 will be described.

In a case where the update notification is supplied from the DB update unit 25, the output unit 26 outputs the fixed processing result out of the provisional processing result candidates of the DB 24 as the three-dimensional coordinates with the color information, the color information of which is corrected. More specifically, in a case where there is a color candidate having likelihood larger than an upper limit threshold (first threshold) determined in advance among the provisional processing result candidates of the DB 24, the output unit 26 outputs the color candidate and the three-dimensional coordinates (x, y, z) as the fixed processing result.

For example, it is assumed that the upper limit threshold is set to 0.8. In the example in FIG. 11, as a result of the update, the color candidate of [foreground color, background color, likelihood]=[blue, red, 1.0] having the likelihood larger than the upper limit threshold 0.8 is output from the output unit 26 as the three-dimensional coordinates with the corrected color information. In contrast, in the example in FIG. 12, since there is no color candidate having the likelihood larger than the upper limit threshold 0.8, the three-dimensional coordinates with the corrected color information are not output.

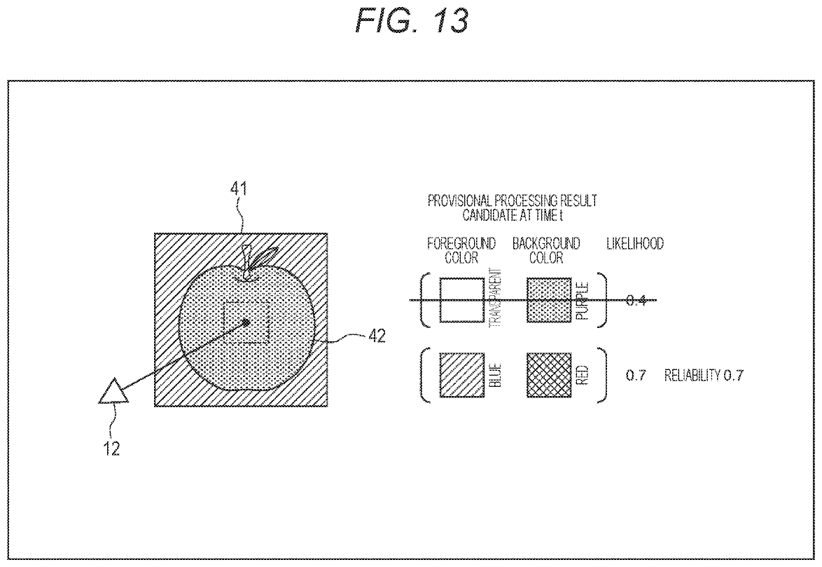

Note that, as an output option, even in a case where there is no color candidate having the likelihood larger than the upper limit threshold 0.8, the likelihood may be added as reliability for the color candidate having the highest likelihood, and the three-dimensional coordinates with color information may be output. For example, as illustrated in FIG. 13, in a case where the color candidate of [foreground color, background color, likelihood]=[transparent, purple, 0.4] and the color candidate of [foreground color, background color, likelihood]=[blue, red, 0.7] are stored in the DB 24 as the unfixed provisional processing result candidates, the output unit 26 outputs the three-dimensional coordinates with color information of [foreground color, background color]=[blue, red], which is the color candidate having the highest likelihood, with the reliability of 0.7. As described above, outputting the three-dimensional coordinates with color information even if this is unfixed is effective in a case where a high-density three-dimensional reconstruction result is required even in a portion having low color reliability, such as collision avoidance of an autonomous robot, for example, in the subsequent processing.

### 2. Color Information Correction Processing According to First Embodiment

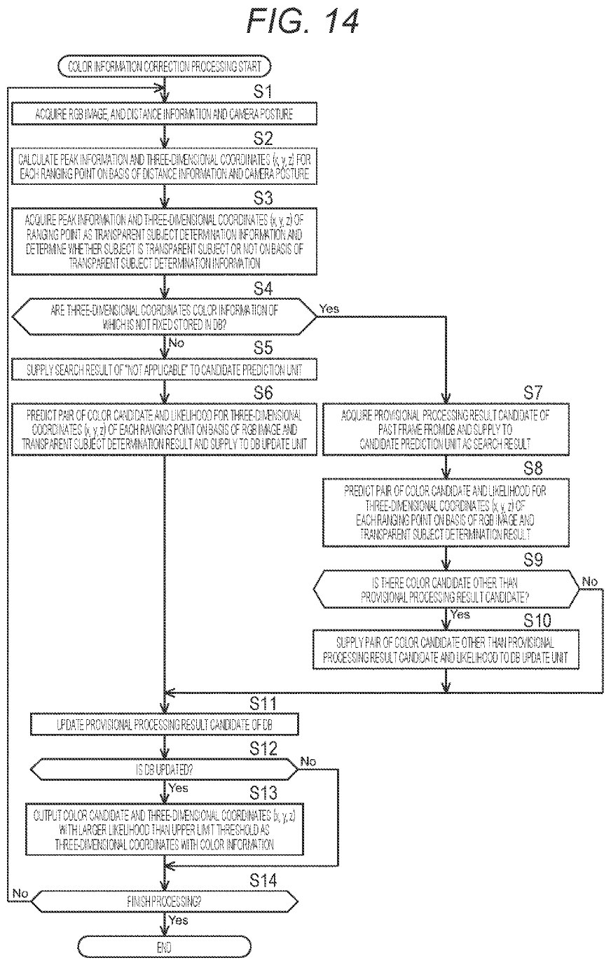

Next, color information correction processing by the signal processing system 1 of the first embodiment will be described with reference to a flowchart in FIG. 14. This processing is started, for example, when the RGB image and distance information are supplied from the RGB camera 11 and the dToF sensor 12.

First, at step S1, the data acquisition unit 21 acquires the RGB image supplied from the RGB camera 11, and the distance information and camera posture supplied from the dToF sensor 12. The data acquisition unit 21 supplies the acquired RGB image to the candidate processing unit 23, and supplies the acquired distance information and camera posture to the distance calculation unit 22.

At step S2, the distance calculation unit 22 calculates the peak information and three-dimensional coordinates (x, y, z) for each ranging point on the basis of the distance information and camera posture from the data acquisition unit 21. More specifically, the distance calculation unit 22 extracts the peak information corresponding to the peak of the count value from the histogram data of the multipixel MP corresponding to the spot light SP, and calculates the peak information and the three-dimensional coordinates (x, y, z) of each peak. The peak information and three-dimensional coordinates (x, y, z) of each peak calculated is supplied to the candidate processing unit 23.

At step S3, the transparent subject determination unit 31 of the candidate processing unit 23 acquires the peak information and the three-dimensional coordinates (x, y, z) of the ranging point from the distance calculation unit 22 as transparent subject determination information, and determines whether or not the subject is the transparent subject on the basis of the transparent subject determination information. Specifically, it is determined whether or not one peak is observed in the histogram of one multipixel MP, and in a case where a plurality of peaks is detected, it is further determined whether the plurality of peaks is due to the object boundary or the transparent subject as described with reference to FIG. 5, thereby determining whether or not the subject is the transparent subject. As described with reference to FIG. 6, the above-described determination may be performed by supplementarily using the output of the additional sensor such as the thermal camera.

At step S4, the search unit 32 searches the DB 24 and determines whether or not the three-dimensional coordinates with unfixed color information having three-dimensional coordinates within a predetermined search range for the three-dimensional coordinates (x, y, z) of the ranging point supplied from the distance calculation unit 22 are stored in the DB 24. In a case where the three-dimensional coordinates with unfixed color information are not detected from the DB 24, the processing proceeds to step S5, and in a case where the three-dimensional coordinates with unfixed color information are detected from the DB 24, the processing proceeds to step S7.

At step S5 in a case where the three-dimensional coordinates with unfixed color information are not detected from the DB 24, the search unit 32 supplies a search result of “not applicable” to the candidate prediction unit 33.

At step S6 after step S5, the candidate prediction unit 33 predicts the pair of color candidate and likelihood for the three-dimensional coordinates (x, y, z) of each ranging point supplied from the distance calculation unit 22 on the basis of the RGB image from the RGB camera 11 and the transparent subject determination result by the transparent subject determination unit 31.

Specifically, in a case where the determination result at step S3 is not the transparent subject, the candidate prediction unit 33 supplies a prediction result of color information in which the color information of the RGB image of the ranging point of interest is set as a color candidate as it is and the likelihood is set to “1” to the DB update unit 25. In contrast, in a case where the determination result at step S3 is the transparent subject, the candidate prediction unit 33 determines a plurality of pairs of color candidate and likelihood by a rule determined in advance or by learning, and supplies the same to the DB update unit 25. The transparent subject determination result by the transparent subject determination unit 31 is also supplied to the DB update unit 25.

In contrast, at step S7 in a case where the three-dimensional coordinates with unfixed color information are detected in the DB 24, the search unit 32 acquires, from the DB 24, a provisional processing result candidate for a past frame including the three-dimensional coordinates with unfixed color information having the three-dimensional coordinates within the search range and the color candidate, and supplies the same to the candidate prediction unit 33 as a search result.

At step S8 after step S7, the candidate prediction unit 33 predicts the pair of color candidate and likelihood for the three-dimensional coordinates (x, y, z) of each ranging point supplied from the distance calculation unit 22 on the basis of the RGB image from the RGB camera 11 and the transparent subject determination result by the transparent subject determination unit 31. The processing at step S8 is similar to that at step S6 described above.

At step S9, the candidate prediction unit 33 determines whether or not there is a color candidate other than the provisional processing result candidate stored in the DB 24 in the prediction result of the color candidate.

At step S9, in a case where it is determined that there is the color candidate other than the provisional processing result candidate, the processing proceeds to step S10, and the candidate prediction unit 33 supplies the pair of color candidate and likelihood other than the provisional processing result candidate stored in the DB 24 to the DB update unit 25. The transparent subject determination result by the transparent subject determination unit 31 is also supplied to the DB update unit 25.

In contrast, in a case where it is determined at step S9 that there is no color candidate other than the provisional processing result candidate, processing at step S10 is skipped.

At step S11, the DB update unit 25 updates the DB 24 on the basis of the transparent subject determination result and the pair of color candidate and likelihood supplied from the candidate prediction unit 33. For example, the provisional processing result candidate for the three-dimensional coordinates with unfixed color information stored in the DB 24 is updated so as to increase the likelihood of the consistent color candidate. After updating the DB 24, the DB update unit 25 supplies an update notification to the output unit 26.

At step S12, the output unit 26 determines whether the DB 24 is updated or not, that is, whether the update notification is supplied from the DB update unit 25 or not.

In a case where it is determined at step S12 that the DB 24 is updated, the processing proceeds to step S13, and the output unit 26 outputs a color candidate having likelihood larger than the upper limit threshold and the three-dimensional coordinates (x, y, z) among the provisional processing result candidates of the DB 24 as the three-dimensional coordinates with fixed color information.

In contrast, in a case where it is determined at step S12 that the DB 24 is not updated, the processing at step S13 is skipped, and the processing proceeds to step S14.

At step S14, the signal processing device 13 determines whether or not to finish the processing. For example, the three-dimensional coordinates with fixed color information are output for all the ranging points of the distance information supplied from the dToF sensor 12, and in a case where the RGB image and the distance information of the next frame are not supplied from the RGB camera 11 and the dToF sensor 12, the signal processing device 13 determines to finish the processing. On the other hand, in a case where the RGB image and the distance information of the next frame are supplied from the RGB camera 11 and the dToF sensor 12, the signal processing device 13 determines not to finish the processing.

In a case where it is determined that the processing is not finished at step S14, the signal processing device 13 returns the processing to step S1.

Therefore, the processing at steps S1 to S14 described above is repeated for the RGB image and the distance information of the next frame.

In contrast, in a case where it is determined at step S14 that the processing is finished, the signal processing device 13 finishes the color information correction processing in FIG. 14.

In the color information correction processing in FIG. 14, in order to simplify the description, a flow of a series of processing in a case where update is performed once for one ranging point is described; however, there is a case where, when the color information and the three-dimensional coordinates (x, y, z) of the ranging point of one frame are fixed, the color information and the three-dimensional coordinates (x, y, z) of the ranging point of the past frame having the corresponding three-dimensional coordinates are sequentially fixed. The signal processing device 13 may recursively update the ranging point of the past frame with unfixed color information. Specifically, in a case where the ranging point of the color candidate having likelihood larger than the upper limit threshold 0.8 appears, the DB update unit 25 supplies the search unit 32 with the fixed color information of the ranging point.

The search unit 32 searches for the three-dimensional coordinates with unfixed color information of the past frame within a predetermined search range of the ranging point with fixed color information. The subsequent processing is similar.

### 3. Variation of First Embodiment

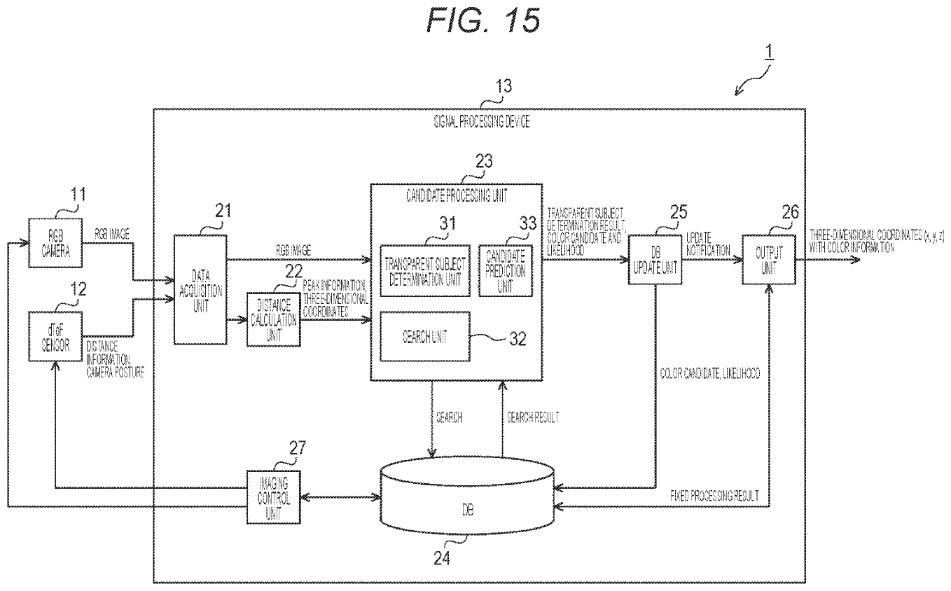

FIG. 15 is a block diagram illustrating a variation of the first embodiment of the signal processing system.

When the signal processing system 1 in FIG. 15 is compared with the configuration of the first embodiment illustrated in FIG. 1, an imaging control unit 27 is newly provided, and the other configurations are similar.

The imaging control unit 27 refers to the provisional processing result candidates stored in the DB 24, calculates a measurement position at which the ranging point with unfixed color information can be fixed, and instructs the RGB camera 11 and the dToF sensor 12 to perform measurement using the calculated measurement position. The RGB camera 11 moves to a measurement position instructed by the imaging control unit 27 and performs imaging. The dToF sensor 12 moves to the measurement position instructed by the imaging control unit 27 and measures a distance. The instruction of the measurement position may be supplied to a mobile body, a robot and the like equipped with the RGB camera 11 and the dToF sensor 12.

According to the variation of the first embodiment in FIG. 15, it is possible to allow the RGB camera 11 and the dToF sensor 12 to perform measurement so as to compensate for a portion of low likelihood (reliability). For example, in robot manipulation and the like, it is possible to drive with high accuracy by imaging to autonomously reduce uncertain elements. Furthermore, also in a case where a human performs imaging, it is possible to reduce rework in imaging for three-dimensional reconstruction by suggesting information such as insufficient imaging conditions from this angle.

According to the signal processing system 1 of the first embodiment described above, an influence of a transmission color of the transparent subject is corrected using the RGB image acquired from the RGB camera 11 and the histogram data acquired from the dToF sensor 12, so that the three-dimensional coordinates and the color information excluding the influence of the transparent subject can be accurately acquired. Therefore, it is possible to perform three-dimensional reconstruction with high color reproduction using the corrected accurate three-dimensional coordinates and color information. Since color reproducibility greatly contributes to appearance of a three-dimensional reconstruction result, high accuracy can be implemented in creation of a CG model and the like by using the present technology.

### 4. Second Embodiment of Signal Processing System

Next, a second embodiment of a signal processing system is described.

In the first embodiment described above, the signal processing system 1 corrects erroneous recognition of color information due to presence of a transparent subject in an imaging direction (line-of-sight direction). In the second embodiment, a signal processing system 1 corrects positional shift of three-dimensional coordinates due to refraction of light of a transparent subject in a case where the transparent subject is present in an imaging direction (line-of-sight direction).

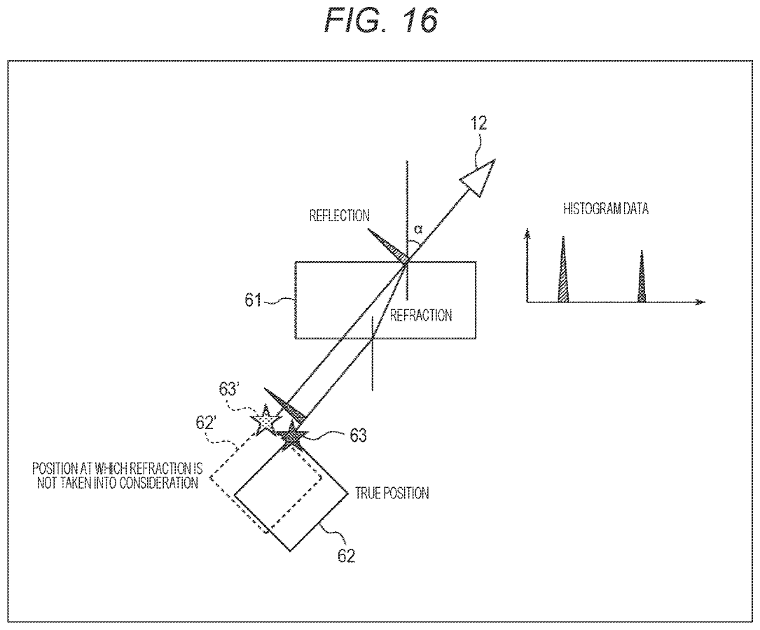

For example, as illustrated in FIG. 16, in a case where a transparent subject 61 is present in a line-of-sight direction of a dToF sensor 12, a distance to a predetermined object is measured via the transparent subject 61. The dToF sensor 12 might measure not as a correct three-dimensional coordinate position (true position) 63 of an object 62 due to refraction of light of the transparent subject 61 but as a three-dimensional coordinate position 63′ of an object 62′ without taking refraction into consideration. The signal processing system 1 of the second embodiment corrects such positional shift of the three-dimensional coordinates due to refraction of light of the transparent subject 61. Furthermore, since light is reflected by the transparent subject 61 depending on an incident angle, the incident angle of light on the transparent subject 61 is also taken into consideration. Similar to the first embodiment, a signal processing device 13 determines whether a subject is a transparent subject or not using histogram data output as distance information by the dToF sensor 12. Then, in a case where the subject is determined to be the transparent subject, the signal processing device 13 corrects the positional shift of the three-dimensional coordinates by predicting a plurality of pairs of candidate for a refractive index and an incident angle of the transparent subject and likelihood by a rule determined in advance or by learning.

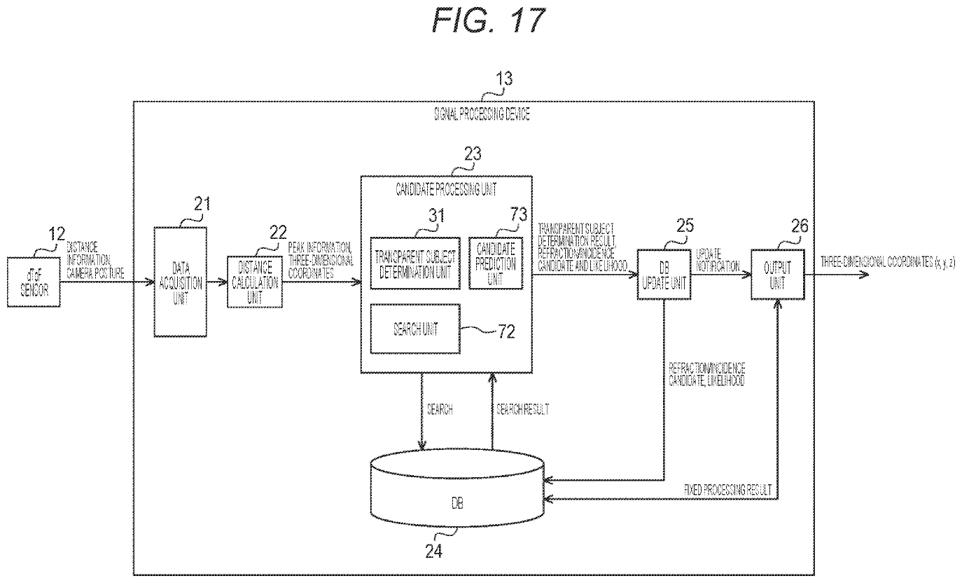

FIG. 17 is a block diagram illustrating a configuration example of the second embodiment of the signal processing system of the present disclosure.

The signal processing system 1 in FIG. 17 includes the dToF sensor 12 and the signal processing device 13. That is, in the second embodiment, since a correction target is not color information but the positional shift of the three-dimensional coordinates due to refraction of light, an RGB camera 11 that generates an RGB image is omitted. It goes without saying that the RGB camera 11 may be provided for the purpose of commonality with the first embodiment.

The signal processing device 13 corrects the positional shift of the three-dimensional coordinates of the object due to refraction and incidence (hereinafter, appropriately referred to as refraction/incidence) of light caused by the transparent subject on the basis of the distance information and camera posture acquired from the dToF sensor 12, and outputs corrected three-dimensional coordinates (x, y, z).

The signal processing device 13 includes a data acquisition unit 21, a distance calculation unit 22, a candidate processing unit 23, a DB 24, a DB update unit 25, and an output unit 26. The candidate processing unit 23 includes a transparent subject determination unit 31, a search unit 72, and a candidate prediction unit 73.

That is, the signal processing device 13 is different in that the candidate processing unit 23 includes the search unit 72 and the candidate prediction unit 73 in place of the search unit 32 and the candidate prediction unit 33 of the first embodiment, and is common in other points.

The search unit 72 and the candidate prediction unit 73 are different in that a pair of refraction/incidence candidate and likelihood is determined in place of the pair of color candidate and likelihood of the first embodiment, and are common in other points. This is hereinafter described in detail.

The search unit 72 searches whether three-dimensional coordinates with unfixed refraction/incidence information having three-dimensional coordinates within a search range of (x±Δx′, y±Δy′, z±Δz′) obtained by adding a predetermined margin to the three-dimensional coordinates (x, y, z) of the ranging point supplied from the distance calculation unit 22 are stored in the DB 24 or not. Margin values Δx′, Δy′, and Δz′ of the three-dimensional coordinates are set in advance as in the first embodiment. In the second embodiment, since the positional shift of the three-dimensional coordinates due to refraction is corrected, the margin is preferably set to be larger than that in the first embodiment. That is, in a case where different margins are set in the first embodiment and the second embodiment, Δx<Δx′, Δy<Δy′, and Δz<Δz′ are satisfied. Note that, the margin values Δx′, Δy′, and Δz′ of the three-dimensional coordinates may be the same as those in the first embodiment.

In a case where the three-dimensional coordinates with unfixed refraction/incidence information having the three-dimensional coordinates within the search range are not stored in the DB 24, the search unit 72 supplies a search result of “not applicable” to the candidate prediction unit 73. In contrast, in a case where the three-dimensional coordinates with unfixed refraction/incidence information having the three-dimensional coordinates within the search range are stored in the DB 24, the search unit 32 acquires, from the DB 24, a provisional processing result candidate for a past frame including the three-dimensional coordinates with unfixed refraction/incidence information and the refraction/incidence candidate, and supplies the same to the candidate prediction unit 73 as the search result.

The candidate prediction unit 73 predicts the refraction/incidence information for the three-dimensional coordinates (x, y, z) of each ranging point supplied from the distance calculation unit 22 on the basis of a transparent subject determination result by the transparent subject determination unit 31, and the search result from the search unit 72. The candidate prediction unit 73 supplies a pair of candidate for the refraction/incidence information (refraction/incidence candidate) and likelihood to the DB update unit 25 as a prediction result of the refraction/incidence information. Furthermore, the candidate prediction unit 73 also supplies the transparent subject determination result by the transparent subject determination unit 31 to the DB update unit 25.

On the basis of the transparent subject determination result and the pair of refraction/incidence candidate and likelihood supplied from the candidate prediction unit 73, the DB update unit 25 updates the provisional processing result candidate for the three-dimensional coordinates with unfixed refraction/incidence information stored in the DB 24. In a case of updating the information stored in the DB 24, the DB update unit 25 supplies an update notification to the output unit 26.

In a case where the update notification is supplied from the DB update unit 25, the output unit 26 outputs corrected three-dimensional coordinates (x, y, z) of the ranging point, which is a fixed processing result stored in the DB 24.

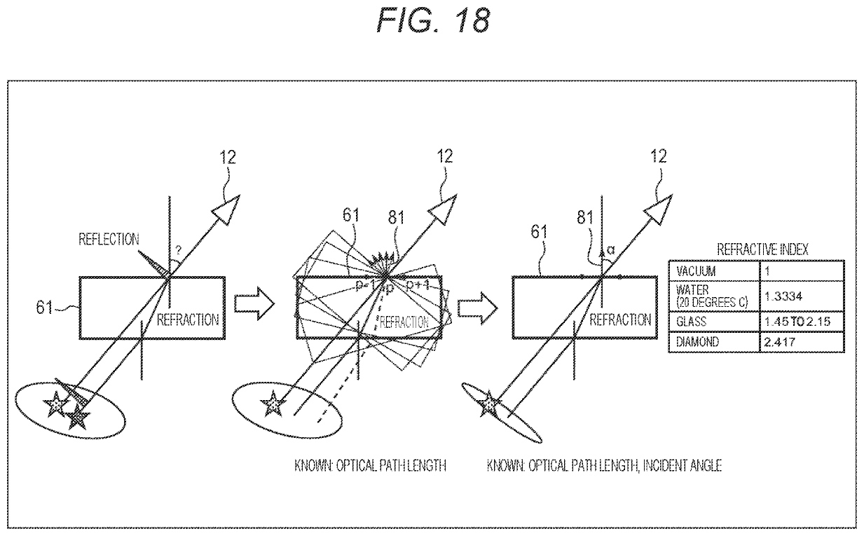

Next, with reference to FIG. 18, processing of predicting the pair of refraction/incidence candidate and likelihood by a rule determined in advance or by learning in a case where the transparent subject determination result of the ranging point of interest is the transparent subject will be further described.

First, the candidate prediction unit 73 assigns some representative values of assumed refractive indexes of glass, water, diamond and the like.

Next, in a case where neighboring ranging points that simultaneously emit light are located in the same transparent subject, the candidate prediction unit 73 calculates a normal vector of the transparent subject by using distance information of the ranging points in the vicinity of the ranging point of interest, and acquires the incident angle. Specifically, a reflection position p of the transparent subject 61 in FIG. 18 is calculated from a distance of a first peak of the histogram data of the ranging point of interest. Similarly, reflection positions (p−1) and (p+1) are calculated from the distance of the first peak of the histogram data of the ranging point in the vicinity of the ranging point of interest. Then, a surface of the transparent subject 61 is detected from the reflection positions (p−1), p, and (p+1), and a normal vector 81 perpendicular to the surface of the transparent subject 61 is detected. An incident angle α is calculated from the camera posture (line-of-sight direction) of the dToF sensor 12 and the normal vector 81.

The candidate prediction unit 73 determines a plurality of pairs of refraction/incidence candidate and likelihood in the above-described manner and supplies the same to the DB update unit 25.

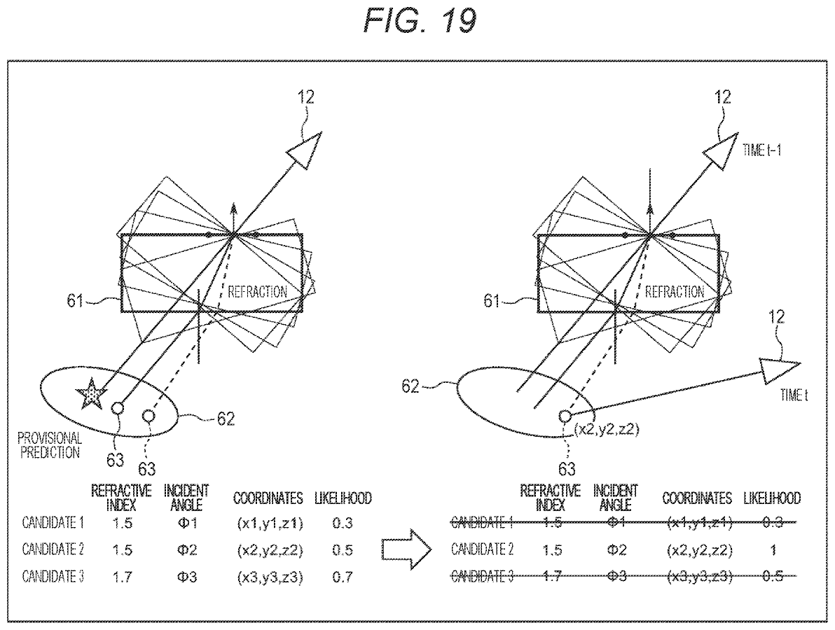

A diagram on a left side in FIG. 19 illustrates an example of the pair of refraction/incidence candidate and likelihood predicted by the candidate prediction unit 73.

When the refractive index and the incident angle of the transparent subject 61 are determined, the three-dimensional coordinates 63 of the object 62 ahead of the transparent subject 61 can be calculated, so that information of the three-dimensional coordinates 63 is also stored in the DB update unit 25.

The likelihood of each refraction/incidence candidate may be set in such a manner that the likelihood of each refraction/incidence candidate is equal in a case where there is no particular prior knowledge, or the likelihood of the refractive index of glass may be set higher. Furthermore, for example, in a case where the subject can be estimated to some extent in advance such as when possibility of waterside is high by an imaging environment and the like, likelihood of predetermined refraction/incidence candidate may be set high accordingly.

On the basis of the transparent subject determination result and the pair of refraction/incidence candidate and likelihood supplied from the candidate prediction unit 33, the DB update unit 25 updates the provisional processing result candidate for the three-dimensional coordinates with unfixed refraction/incidence information stored in the DB 24 as in the first embodiment.

For example, as illustrated in a right diagram in FIG. 19, in a case where the transparent subject determination result at a time t is not a transparent subject, the refractive index and the incident angle are fixed to a candidate 2 that matches (x2, y2, z2) being the three-dimensional coordinates 63 of the object 62 at the time t, out of candidates 1 to 3 that are provisional processing result candidates for the past frame. The DB update unit 25 corrects the likelihood of the candidate 2 to “1” and deletes other refraction/incidence candidates, that is, the candidates 1 and 3 from the DB 24.

In the second embodiment also, candidates can be predicted using a predictor learned by a neural network, instead of determining refraction/incidence candidates on the basis of rules. For example, in order to take refraction into consideration, an MLP model that handles non-linear light rays referred to as D-NeRF can be utilized. D-NeRF is disclosed, for example, in “D-NeRF: Neural Radiance Fields for Dynamic Scenes”, Albert Pumarola, Enric Corona, Gerard Pons-Moll, Francesc Moreno-Noguer, https://arxiv.org/abs/2011.13961.

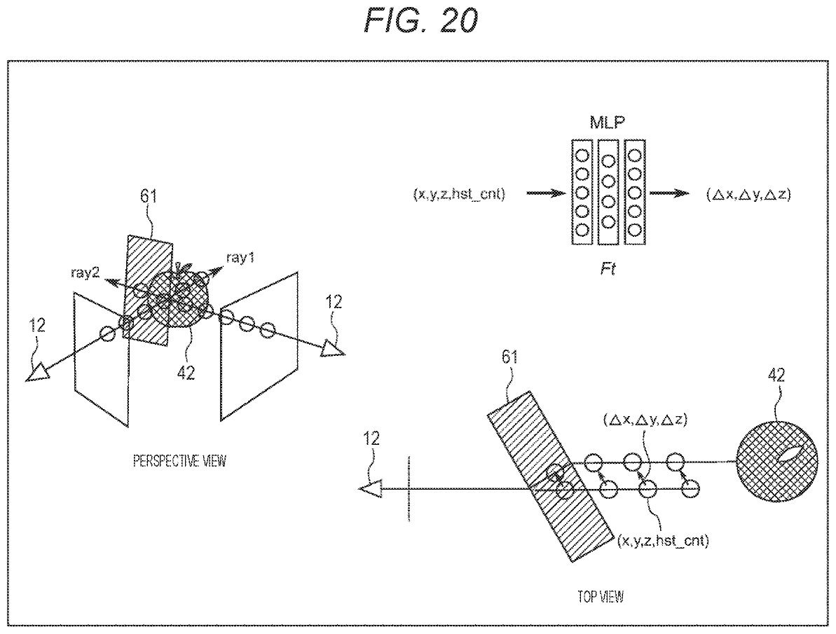

As illustrated in FIG. 20, the MLP model of D-NeRF does not explicitly handle the refractive index and the incident angle, but directly learns positional shift (Δx, Δy, Δz) with respect to the three-dimensional coordinates (x, y, z) using the camera posture and histogram data (x, y, z, hst_cnt) as inputs. A function Ft of the MLP model such that a difference between the histogram data rendered by the light beam of each viewpoint and correct histogram data is minimized is learned using the histogram data hst_cnt from multiple viewpoints as an input. A positional shift (Δx, Δy, Δz) of the dToF sensor 12 from a predetermined camera posture (line-of-sight direction) is predicted using the function Ft of the MLP model obtained by learning.

Note that, not only the positional shift (Δx, Δy, Δz) but also the RGB value and density σ (RGBσ) can be predicted using the MLP model of D-NeRF as in the first embodiment. In this case, each of the function Ft that predicts (learns) the positional shift (Δx, Δy, Δz) using the camera posture of the dToF sensor 12 and the histogram data (x, y, z, hst_cnt) as an input, and the function F that predicts (learns) the RGB value and density σ (RGBσ) using the positional shift (x+Δx, y+Δy, z+Δz) as an input are expressed by the MLP model. In other words, the function F of the MLP model predicts the RGB value and density σ (RGBσ) on the light beam in consideration of the positional shift (x+Δx, y+Δy, z+Δz) using the positional shift (x+Δx, y+Δy, z+Δz) of the light beam predicted by the function Ft as an input. Therefore, by a combined function Ft·F of the function Et and the function F, it is possible to output the luminance (RGB value) and density σ (RGBσ) on the light beam on the position considering refraction using the camera posture of the dToF sensor 12 and the histogram data (x, y, z, hst_cnt) as an input. In the learning, the combined function Ft·F is learned in such a manner that a difference between the luminance value rendered for each light beam and histogram data and the correct data is minimized, using the histogram data hst_cnt from the multiple viewpoints as the input and the histogram data and RGB image of each viewpoint as teacher data.

### 5. Positional Shift Correction Processing According to Second Embodiment

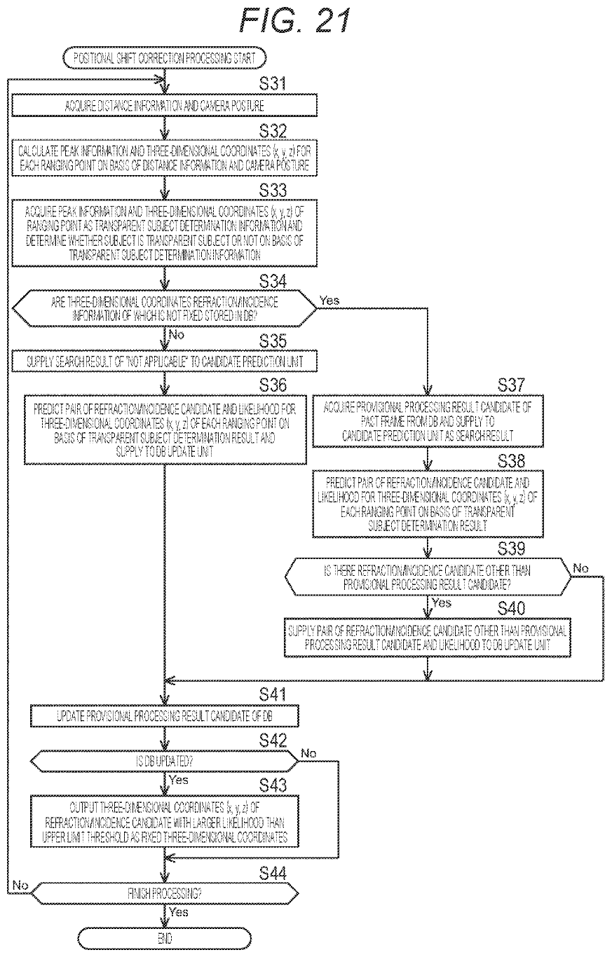

Next, positional shift correction processing by the signal processing system 1 of the second embodiment will be described with reference to a flowchart in FIG. 21. This processing is started, for example, when the distance information is supplied from the dToF sensor 12.

First, at step S31, the data acquisition unit 21 acquires the distance information and the camera posture supplied from the dToF sensor 12. The data acquisition unit 21 supplies the acquired distance information and camera posture to the distance calculation unit 22.

At step S32, the distance calculation unit 22 calculates the peak information and three-dimensional coordinates (x, y, z) for each ranging point on the basis of the distance information and camera posture from the data acquisition unit 21. More specifically, the distance calculation unit 22 extracts the peak information corresponding to the peak of the count value from the histogram data of the multipixel MP corresponding to the spot light SP, and calculates the peak information and the three-dimensional coordinates (x, y, z) of each peak. The peak information and three-dimensional coordinates (x, y, z) of each peak calculated is supplied to the candidate processing unit 23.

At step S33, the transparent subject determination unit 31 of the candidate processing unit 23 acquires the peak information and the three-dimensional coordinates (x, y, z) of the ranging point from the distance calculation unit 22 as transparent subject determination information, and determines whether or not the subject is the transparent subject on the basis of the transparent subject determination information. A method of determining the transparent subject is similar to that in the first embodiment described above.

At step S34, the search unit 32 searches the DB 24 and determines whether or not the three-dimensional coordinates with unfixed refraction/incidence information having three-dimensional coordinates within a predetermined search range for the three-dimensional coordinates (x, y, z) of the ranging point supplied from the distance calculation unit 22 are stored in the DB 24. The search range is set to be wider than that in the first embodiment, for example. In a case where the three-dimensional coordinates with unfixed refraction/incidence information are not detected from the DB 24, the processing proceeds to step S35, and in a case where the three-dimensional coordinates with unfixed refraction/incidence information are detected from the DB 24, the processing proceeds to step S37.

At step S35 in a case where the three-dimensional coordinates with unfixed refraction/incidence information are not detected from the DB 24, the search unit 32 supplies a search result of “not applicable” to the candidate prediction unit 73.

At step S36 after step S35, the candidate prediction unit 73 predicts the pair of refraction/incidence candidate and likelihood for the three-dimensional coordinates (x, y, z) of each ranging point supplied from the distance calculation unit 22 on the basis of the transparent subject determination result by the transparent subject determination unit 31.

Specifically, in a case where the determination result at step S33 is not the transparent subject, the candidate prediction unit 33 calculates the three-dimensional coordinates on the assumption that there is no positional shift of the ranging point of interest, and supplies the prediction result of the position information with the likelihood of “1” to the DB update unit 25. In contrast, in a case where the determination result at step S33 is the transparent subject, the candidate prediction unit 33 determines a plurality of pairs of refraction/incidence candidate and likelihood by a rule determined in advance or by learning, and supplies the same to the DB update unit 25. The transparent subject determination result by the transparent subject determination unit 31 is also supplied to the DB update unit 25.

In contrast, at step S37 in a case where the three-dimensional coordinates with unfixed refraction/incidence information are detected from the DB 24, the search unit 32 acquires, from the DB 24, a provisional processing result candidate for a past frame including the three-dimensional coordinates with unfixed refraction/incidence information having the three-dimensional coordinates within the search range and the refraction/incidence candidate, and supplies the same to the candidate prediction unit 73 as a search result.

At step S38 after step S37, the candidate prediction unit 73 predicts the pair of refraction/incidence candidate and likelihood for the three-dimensional coordinates (x, y, z) of each ranging point supplied from the distance calculation unit 22 on the basis of the transparent subject determination result by the transparent subject determination unit 31. The processing at step S38 is similar to that at step S36 described above.

At step S39, the candidate prediction unit 73 determines whether or not there is a color candidate other than the provisional processing result candidate stored in the DB 24 in the prediction result of the refraction/incidence candidate.

At step S39, in a case where it is determined that there is the refraction/incidence candidate other than the provisional processing result candidate, the processing proceeds to step S40, and the candidate prediction unit 73 supplies the pair of refraction/incidence candidate and likelihood other than the provisional processing result candidate stored in the DB 24 to the DB update unit 25. The transparent subject determination result by the transparent subject determination unit 31 is also supplied to the DB update unit 25.

In contrast, in a case where it is determined at step S39 that there is no refraction/incidence candidate other than the provisional processing result candidate, processing at step S40 is skipped.

At step S41, the DB update unit 25 updates the DB 24 on the basis of the transparent subject determination result and the pair of refraction/incidence candidate and likelihood supplied from the candidate prediction unit 73. For example, the provisional processing result candidate for the three-dimensional coordinates with unfixed refraction/incidence information stored in the DB 24 is updated so as to increase the likelihood of the consistent refraction/incidence candidate. After updating the DB 24, the DB update unit 25 supplies an update notification to the output unit 26.

At step S42, the output unit 26 determines whether the DB 24 is updated or not, that is, whether the update notification is supplied from the DB update unit 25 or not.

In a case where it is determined at step S42 that the DB 24 is updated, the processing proceeds to step S43, and the output unit 26 outputs the three-dimensional coordinates (x, y, z) of the refraction/incidence candidate having likelihood larger than the upper limit threshold out of the provisional processing result candidates of the DB 24 as fixed three-dimensional coordinates.

In contrast, in a case where it is determined at step S42 that the DB 24 is not updated, the processing at step S43 is skipped, and the processing proceeds to step S44.

At step S44, the signal processing device 13 determines whether or not to finish the processing. For example, the fixed three-dimensional coordinates are output for all the ranging points of the distance information supplied from the dToF sensor 12, and in a case where the distance information of the next frame is not supplied from the dToF sensor 12, the signal processing device 13 determines to finish the processing. On the other hand, in a case where the distance information of the next frame is supplied from the dToF sensor 12, the signal processing device 13 determines not to finish the processing.

In a case where it is determined that the processing is not finished at step S44, the signal processing device 13 returns the processing to step S31. Therefore, the processing at steps S31 to S44 described above is repeated for the distance information of the next frame.

In contrast, in a case where it is determined at step S44 that the processing is finished, the signal processing device 13 finishes the positional shift correction processing in FIG. 21.

In the positional shift correction processing in FIG. 21, in order to simplify the description, a flow of a series of processing in a case where update is performed once for one ranging point is described; however, there is a case where, when the three-dimensional coordinates (x, y, z) of the ranging point of one frame are fixed, the three-dimensional coordinates (x, y, z) of the ranging point of the past frame having the corresponding three-dimensional coordinates are sequentially fixed. The signal processing device 13 may recursively update the ranging point of the past frame with unfixed three-dimensional coordinates.

Specifically, in a case where the ranging point of the refraction/incidence candidate having likelihood larger than the upper limit threshold 0.8 appears, the DB update unit 25 supplies the search unit 72 with the fixed three-dimensional coordinate information of the ranging point. The search unit 72 searches for the three-dimensional coordinates with unfixed refraction/incidence information of the past frame within a predetermined search range of the ranging point with fixed three-dimensional coordinates. The subsequent processing is similar.

In the positional shift correction processing of the second embodiment also, as in the first embodiment, even in a case where there is no three-dimensional coordinates having likelihood larger than the upper limit threshold 0.8, the three-dimensional coordinates of the refraction/incidence candidate having the largest likelihood may be output with the likelihood added as reliability.

According to the signal processing system 1 of the second embodiment described above, an influence of the positional shift by refraction of light when passing through the transparent subject is corrected using the histogram data acquired from the dToF 12 sensor, so that the three-dimensional coordinates excluding the influence of refraction of the transparent subject can be accurately acquired. The positional shift due to refraction causes the coordinates of a reconstruction result to be shifted for each viewpoint, thereby causing blurring of an object to be reconstructed and reducing the accuracy of the reconstruction result; however, by using the corrected accurate three-dimensional coordinates, highly accurate three-dimensional reconstruction can be performed.

In the second embodiment described above also, as in the variation of the first embodiment in FIG. 15, it is possible to adopt a configuration in which the measurement position is fed back so as to measure the ranging point with unfixed three-dimensional coordinates.

### 6. Conclusion

A signal processing device 13 includes a data acquisition unit 21 that acquires histogram data of a flight time of irradiation light to a subject, a distance calculation unit 22 that calculates three-dimensional coordinates of the subject on the basis of the acquired histogram data and a camera posture of a dToF sensor 12 that generates the histogram data, a transparent subject determination unit 31 that determines whether the subject is a transparent subject on the basis of peak information indicated by the histogram data and three-dimensional coordinates of the subject calculated on the basis of the histogram data, and an output unit 26 that outputs the three-dimensional coordinates of the subject in which color information or three-dimensional coordinates of the subject is corrected on the basis of a transparent subject determination result of the transparent subject determination unit 31.

Furthermore, in the first embodiment, the signal processing device 13 includes a candidate prediction unit 33 that predicts a candidate for color information of a subject on the basis of the peak information, three-dimensional coordinates of the subject, and a transparent subject determination result, a DB 24 (storage unit) that stores the color candidate and likelihood predicted by the candidate prediction unit 33, and a DB update unit 25 that updates the color candidate of the DB 24.

In contrast, in the second embodiment, the signal processing device 13 includes a candidate prediction unit 33 that predicts candidates (refraction/incidence candidates) of refraction and incidence information of light of a subject on the basis of peak information, three-dimensional coordinates of the subject, and a transparent subject determination result, a DB 24 (storage unit) that stores the refraction/incidence candidates and likelihood predicted by the candidate prediction unit 33, and a DB update unit 25 that updates the refraction/incidence candidates of the DB 24.

According to the signal processing device 13, by using the histogram data of the flight time of the irradiation light with respect to the subject, it is possible to accurately acquire the distance information or the color information in a case where the transparent subject is present. That is, by detecting a plurality of peaks caused by the transparent subject, it is possible to accurately correct the distance to the subject, to correct color information of the transparent subject, and to correct three-dimensional coordinates due to refraction of light of the transparent subject.

According to the above-described correction processing of the signal processing device 13, an imaged scene is temporarily determined by the parameters learned in advance or the rule designed in advance, the likelihood is determined, and the likelihood is recursively corrected at the timing when the additional information is input later, so that the best selection can be made on the spot.

The signal processing device 13 may have only one of the configurations and functions of the first embodiment and the second embodiment described above, or may have both of the configurations and functions; for example, this may selectively perform one of the processes by switching between a first operation mode corresponding to the first embodiment and a second operation mode corresponding to the second embodiment. Alternatively, the color information correction processing of the first embodiment and the positional shift correction processing of the second embodiment may be executed in parallel, and a result obtained by integrating both correction results may be output as a correction processing result.

### <Application Example of Present Technology>

The correction processing of the present disclosure in which three-dimensional coordinates and color information are corrected using histogram data acquired from the dToF 12 sensor can be applied to three-dimensional measurement of various applications such as simultaneous localization and mapping (SLAM) in which self-position estimation and environment map creation are simultaneously performed, robot operation in which an object is grasped and moved or worked, CG modeling in a case where a virtual scene or object is generated by computer graphics (CG), object recognition processing, object classification processing, and the like. By applying the correction processing of the present disclosure, the measurement accuracy of the three-dimensional coordinates of the object can be improved.

### 7. Computer Configuration Example

The above-described series of processing can be executed by hardware or software. In a case where the series of processing is executed by the software, a program that configures the software is installed in a computer. Here, the computer includes a microcomputer incorporated in dedicated hardware, a general-purpose personal computer capable of executing various functions by installing various programs and the like, for example.

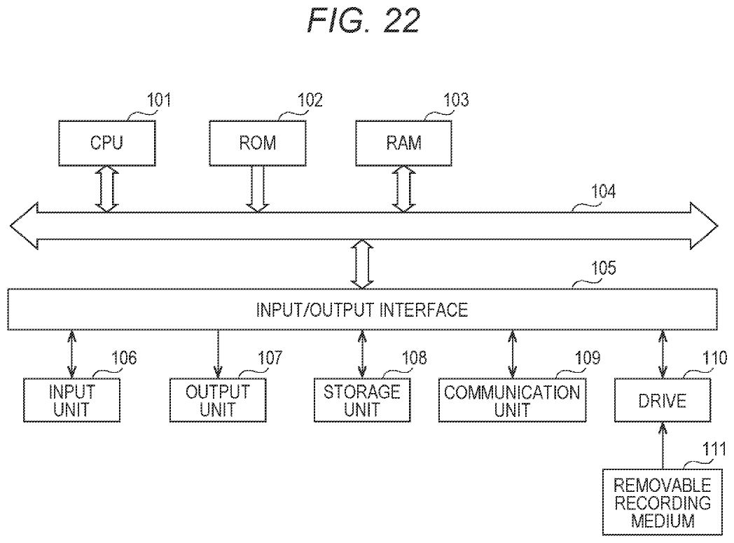

FIG. 22 is a block diagram illustrating a configuration example of hardware of a computer that executes the above-described series of processes by a program.

In the computer, a central processing unit (CPU) 101, a read only memory (ROM) 102, and a random access memory (RAM) 103 are mutually connected by a bus 104.

The bus 104 is further connected with an input/output interface 105. An input unit 106, an output unit 107, a storage unit 108, a communication unit 109, and a drive 110 are connected to the input/output interface 105.

The input unit 106 includes a keyboard, a mouse, a microphone, a touch panel, an input terminal and the like. The output unit 107 includes a display, a speaker, an output terminal and the like. The storage unit 108 includes a hard disk, a RAM disk, a non-volatile memory and the like. The communication unit 109 includes a network interface and the like. The drive 110 drives a removable recording medium 111 such as a magnetic disk, an optical disk, a magneto-optical disk, or a semiconductor memory.

In the computer configured in the above-described manner, the CPU 101 loads the program stored in the storage unit 108, for example, on the RAM 103 via the input/output interface 105 and the bus 104 to execute, so that a series of processing described above is performed.

The RAM 103 also stores data necessary for the CPU 101 to execute various kinds of processing as appropriate.

The program executed by the computer (CPU 101) can be recorded on the removable recording medium 111 as a package medium and the like, for example to be provided. Furthermore, the program can be provided via a wired or wireless transmission medium such as a local area network, the Internet, or digital satellite broadcasting.

In the computer, by attaching a removable recording medium 111 to a drive 110, the program can be installed in a storage unit 108 via an input/output interface 105. Furthermore, the program can be received by a communication unit 109 via a wired or wireless transmission medium and installed on the storage unit 108. In addition, the program can be installed on the ROM 102 or the storage unit 108 in advance.

Note that, the program executed by the computer may be a program for processing in time series in the order described in the present specification, or a program for processing in parallel or at a necessary timing such as when a call is made.

In the present specification, a system is intended to mean assembly of a plurality of components (devices, modules (parts) and the like) and it does not matter whether or not all the components are in the same housing. Therefore, a plurality of devices housed in separate housings and connected via a network and one device in which a plurality of modules is housed in one housing are both systems.

Furthermore, the embodiment of the present disclosure is not limited to the above-described embodiments and various modifications may be made without departing from the gist of the present disclosure.

Note that, the effects described in the present specification are merely examples and are not limited, and there may be effects other than those described in the present specification.

Note that the technology of the present disclosure can have the following configurations.
(1) A signal processing device including:
an acquisition unit that acquires histogram data of a flight time of irradiation light to a subject;
a transparent subject determination unit that determines whether or not the subject is a transparent subject on the basis of peak information indicated by the histogram data and three-dimensional coordinates of the subject calculated on the basis of the histogram data; and
an output unit that outputs the three-dimensional coordinates of the subject in which color information or three-dimensional coordinates of the subject is corrected on the basis of a transparent subject determination result of the transparent subject determination unit.
(2) The signal processing device according to (1) described above, in which
the transparent subject determination unit determines whether or not the subject is the transparent subject on the basis of whether one peak is observed or a plurality of peaks is observed in the histogram data.
(3) The signal processing device according to (2) described above, in which
in a case where a plurality of peaks is observed in the histogram data, the transparent subject determination unit determines whether the plurality of peaks is due to the transparent subject or an object boundary.
(4) The signal processing device according to (3) described above, in which
the transparent subject determination unit determines that the plurality of peaks is due to the transparent subject in a case where the plurality of peaks is uniformly detected in a plurality of pixels, and determines that the plurality of peaks is due to the object boundary in a case where there is a bias in pixels in which the plurality of peaks is detected.
(5) The signal processing device according to (2) described above, in which
the transparent subject determination unit solves a boundary identification problem using three-dimensional coordinates corresponding to a plurality of peaks to determine whether the plurality of peaks is due to the transparent subject or an object boundary.
(6) The signal processing device according to any one of (1) to (5) described above, in which
the transparent subject determination unit determines whether the subject is the transparent subject on the basis of the peak information, the three-dimensional coordinates of the subject, and a thermo image of the subject.
(7) The signal processing device according to any one of (1) to (6) described above, further including
a candidate prediction unit that predicts a candidate for the color information of the subject on the basis of the peak information, the three-dimensional coordinates of the subject, and the transparent subject determination result, in which
the output unit outputs three-dimensional coordinates with color information of the subject using color information selected from candidates for the color information of the subject as corrected color information.
(8) The signal processing device according to (7) described above, in which
in a case where the transparent subject determination result is the transparent subject, the candidate prediction unit predicts a pair of a color candidate that is the candidate for the color information of the subject and likelihood.
(9) The signal processing device according to (8) described above, in which
the output unit selects three-dimensional coordinates of a color candidate having likelihood larger than a first threshold out of the candidates for the color information of the subject, and outputs the three-dimensional coordinates as three-dimensional coordinates with color information of the subject.
(10) The signal processing device according to any one of (1) to (9) described above, further including
a calculation unit that calculates the three-dimensional coordinates of the subject on the basis of the histogram data and a camera posture of a ranging sensor that generates the histogram data.
(11) The signal processing device according to any one of (8) to (10) described above, further including:
a storage unit that stores the color candidate and likelihood predicted by the candidate prediction unit; and
an update unit that deletes the color candidate having likelihood smaller than a second threshold from the storage unit.
(12) The signal processing device according to (7) described above, in which
the candidate prediction unit determines a color candidate that is the candidate for the color information of the subject using a predictor learned by a neural network.
(13) The signal processing device according to (12) described above, in which
the predictor predicts luminance and density at each point in an imaging space using an RGB image of the subject, a camera posture of a ranging sensor that generates the histogram data, and the histogram data as an input.
(14) The signal processing device according to any one of (8) to (10), further including:
a storage unit that stores the color candidate and likelihood predicted by the candidate prediction unit; and
a control unit that calculates a measurement position on the basis of the color candidate in the storage unit and instructs a ranging sensor that generates the histogram data to perform measurement at the measurement position.
(15) The signal processing device according to any one of (1) to (14) described above, further including
a candidate prediction unit that predicts a candidate for refraction and incidence information of light of the subject on the basis of the peak information, the three-dimensional coordinates of the subject, and the transparent subject determination result, in which
the output unit outputs three-dimensional coordinates of refraction and incidence information selected out of candidates for the refraction and incidence information as the three-dimensional coordinates of the subject with corrected three-dimensional coordinates.
(16) The signal processing device according to (15) described above, in which
in a case where the transparent subject determination result is the transparent subject, the candidate prediction unit predicts a plurality of pairs of refraction/incidence candidate that is the candidate for refraction and incidence information of the subject and likelihood.
(17) The signal processing device according to (15) or (16), in which
the output unit selects three-dimensional coordinates of a refraction and incidence information candidate having likelihood larger than a first threshold out of the candidates for refraction and incidence information of the subject, and outputs the three-dimensional coordinates as three-dimensional coordinates of the subject with corrected three-dimensional coordinates.
(18) The signal processing device according to any one of (1) to (14), further including
a candidate prediction unit that predicts a positional shift of the three-dimensional coordinates of the subject using a predictor that learns the positional shift of the three-dimensional coordinates due to refraction of light of the subject by a neural network, in which
the output unit outputs the three-dimensional coordinates of the subject with corrected positional shift of the three-dimensional coordinates of the subject by the candidate prediction unit.
(19) The signal processing device according to (18) described above, in which
the predictor predicts the positional shift of the three-dimensional coordinates due to refraction of light of the subject using a camera posture of a ranging sensor that generates the histogram data, and the histogram data as an input.
(20) A signal processing method including:
acquiring histogram data of a flight time of irradiation light to a subject;
determining whether or not the subject is a transparent subject on the basis of peak information indicated by the histogram data and three-dimensional coordinates of the subject calculated on the basis of the histogram data; and
outputting the three-dimensional coordinates of the subject in which color information or three dimensional coordinates of the subject is corrected on the basis of a determination result of the transparent subject
by a signal processing device.

REFERENCE SIGNS LIST

| | |
|---|---|
| 11 | RGB camera |
| 12 | dToF sensor |
| 13 | Signal processing device |
| 21 | Data acquisition unit |
| 22 | Distance calculation unit |
| 23 | Candidate processing unit |
| 25 | DB update unit |
| 26 | Output unit |
| 27 | Imaging control unit |
| 31 | Transparent subject determination unit |
| 32 | Search unit |
| 33 | Candidate prediction unit |
| 41 | Transparent subject |
| 42 | Apple |
| 61 | Transparent subject |
| 72 | Search unit |
| 73 | Candidate prediction unit |
| 101 | CPU |
| 102 | ROM |
| 104 | Bus |
| 105 | Input/output interface |
| 106 | Input unit |
| 107 | Output unit |
| 108 | Storage unit |
| 109 | Communication unit |
| 110 | Drive |
| 111 | Removable recording medium |

1. A signal processing device comprising:
an acquisition unit that acquires histogram data of a flight time of irradiation light to a subject;
a transparent subject determination unit that determines whether or not the subject is a transparent subject on a basis of peak information indicated by the histogram data and three-dimensional coordinates of the subject calculated on a basis of the histogram data; and
an output unit that outputs the three-dimensional coordinates of the subject in which color information or three-dimensional coordinates of the subject is corrected on a basis of a transparent subject determination result of the transparent subject determination unit.

2. The signal processing device according to claim 1, wherein
the transparent subject determination unit determines whether or not the subject is the transparent subject on a basis of whether one peak is observed or a plurality of peaks is observed in the histogram data.

3. The signal processing device according to claim 2, wherein
in a case where a plurality of peaks is observed in the histogram data, the transparent subject determination unit determines whether the plurality of peaks is due to the transparent subject or an object boundary.

4. The signal processing device according to claim 3, wherein
the transparent subject determination unit determines that the plurality of peaks is due to the transparent subject in a case where the plurality of peaks is uniformly detected in a plurality of pixels, and determines that the plurality of peaks is due to the object boundary in a case where there is a bias in pixels in which the plurality of peaks is detected.

5. The signal processing device according to claim 2, wherein
the transparent subject determination unit solves a boundary identification problem using three-dimensional coordinates corresponding to a plurality of peaks to determine whether the plurality of peaks is due to the transparent subject or an object boundary.

6. The signal processing device according to claim 1, wherein
the transparent subject determination unit determines whether the subject is the transparent subject on a basis of the peak information, the three-dimensional coordinates of the subject, and a thermo image of the subject.

7. The signal processing device according to claim 1, further comprising
a candidate prediction unit that predicts a candidate for the color information of the subject on a basis of the peak information, the three-dimensional coordinates of the subject, and the transparent subject determination result, wherein
the output unit outputs three-dimensional coordinates with color information of the subject using color information selected from candidates for the color information of the subject as corrected color information.

8. The signal processing device according to claim 7, wherein
in a case where the transparent subject determination result is the transparent subject, the candidate prediction unit predicts a pair of a color candidate that is the candidate for the color information of the subject and likelihood.

9. The signal processing device according to claim 8, wherein
the output unit selects three-dimensional coordinates of a color candidate having likelihood larger than a first threshold out of the candidates for the color information of the subject, and outputs the three-dimensional coordinates as three-dimensional coordinates with color information of the subject.

10. The signal processing device according to claim 1, further comprising
a calculation unit that calculates the three-dimensional coordinates of the subject on a basis of the histogram data and a camera posture of a ranging sensor that generates the histogram data.

11. The signal processing device according to claim 8, further comprising:
a storage unit that stores the color candidate and likelihood predicted by the candidate prediction unit; and
an update unit that deletes the color candidate having likelihood smaller than a second threshold from the storage unit.

12. The signal processing device according to claim 7, wherein
the candidate prediction unit determines a color candidate that is the candidate for the color information of the subject using a predictor learned by a neural network.

13. The signal processing device according to claim 12, wherein
the predictor predicts luminance and density at each point in an imaging space using an RGB image of the subject, a camera posture of a ranging sensor that generates the histogram data, and the histogram data as an input.

14. The signal processing device according to claim 8, further comprising:
a storage unit that stores the color candidate and likelihood predicted by the candidate prediction unit; and
a control unit that calculates a measurement position on a basis of the color candidate in the storage unit and instructs a ranging sensor that generates the histogram data to perform measurement at the measurement position.

15. The signal processing device according to claim 1, further comprising
a candidate prediction unit that predicts a candidate for refraction and incidence information of light of the subject on a basis of the peak information, the three-dimensional coordinates of the subject, and the transparent subject determination result, wherein
the output unit outputs three-dimensional coordinates of refraction and incidence information selected out of candidates for the refraction and incidence information as the three-dimensional coordinates of the subject with corrected three-dimensional coordinates.

16. The signal processing device according to claim 15, wherein
in a case where the transparent subject determination result is the transparent subject, the candidate prediction unit predicts a plurality of pairs of refraction/incidence candidate that is the candidate for refraction and incidence information of light of the subject and likelihood.

17. The signal processing device according to claim 15, wherein
the output unit selects three-dimensional coordinates of a refraction and incidence information candidate having likelihood larger than a first threshold out of the candidates for refraction and incidence information of the subject, and outputs the three-dimensional coordinates as three-dimensional coordinates of the subject with corrected three-dimensional coordinates.

18. The signal processing device according to claim 1, further comprising
a candidate prediction unit that predicts a positional shift of the three-dimensional coordinates of the subject using a predictor that learns the positional shift of the three-dimensional coordinates due to refraction of light of the subject by a neural network, wherein
the output unit outputs the three-dimensional coordinates of the subject with corrected positional shift of the three-dimensional coordinates of the subject by the candidate prediction unit.

19. The signal processing device according to claim 18, wherein
the predictor predicts the positional shift of the three-dimensional coordinates due to refraction of light of the subject using a camera posture of a ranging sensor that generates the histogram data, and the histogram data as an input.

20. A signal processing method comprising:
acquiring histogram data of a flight time of irradiation light to a subject;
determining whether or not the subject is a transparent subject on a basis of peak information indicated by the histogram data and three-dimensional coordinates of the subject calculated on a basis of the histogram data; and
outputting the three-dimensional coordinates of the subject in which color information or three-dimensional coordinates of the subject is corrected on a basis of a determination result of the transparent subject
by a signal processing device.
